(19) United States
(12) Patent Application Publication
(10) Pub. No.: US 2009/0227373 A1
(43) Pub. Date: Sep. 10, 2009

(54) GAME PROGRAM, GAME DEVICE, AND GAME CONTROL METHOD

(75) Inventor: Nariaki YAMAMOTO, Nishinomiya (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 12/397,782

(22) Filed: Mar. 4, 2009

(30) Foreign Application Priority Data
Mar. 6, 2008 (JP) 2008-055854

(51) Int. Cl. G05G 9/047; A63F 9/24

(52) U.S. Cl. 463/38; 463/43

(57) ABSTRACT

The present invention is related to reducing difference between a period of time elapsing until a first moving object moving in conjunction with a motion of a first character passes through a plane and a period of time elapsing until a second moving object released by a second character passes through he plane. A first moving object moving in conjunction with a motion of a first character is displayed on an image display unit with image data for the first moving object. Then, arrival time elapsing since a second moving object is released by a second character until the second moving object arrives at a predicted passage plane is computed based on velocity of the second moving object and distance from a position of the second moving object when the first moving object starts performing a motion to the predicted passage plane. Next, a control unit executes processing of correcting base arrival time for reducing absolute value of difference between the base arrival time and the arrival time. Thereby difference between the period of time required for arrival of the first moving object at the predicted passage plane and the period of time required for arrival of the second moving object at the predicted passage plane.

### CROSS-REFERENCE TO RELATED APPLICATIONS

This application claims priority under 35 U.S.C. §119 to Japanese Patent Application No. 2008-055854 filed on Mar. 6, 2008. The entire disclosure of Japanese Patent Application No. 2008-055854 is hereby incorporated herein by reference.

### BACKGROUND OF THE INVENTION

1. Field of the Invention

The present invention generally relates to a game program, and more specifically to a game program for realizing a game of displaying a first moving object and a second moving object on an image display unit. Here, the first moving object moves in conjunction with a motion of a first character. The second moving object is released by a second character. In addition, the present invention relates to a game device allowed to execute the game program, and a game control method controlled by a computer based on the game program.

A variety of video games have been conventionally proposed. The video games are executed in a game device. For example, a game device generally includes a monitor, a game console, and an input unit (e.g., a game controller). Here, the game console is provided separately from the monitor. The input unit is provided separately from the game console. A plurality of input buttons are arranged on the game controller. Also, a portable game device includes a game console, a liquid-crystal display (LCD) monitor, and input units (e.g., a plurality of input buttons). In this case, the LCD monitor is arranged in the approximately center part of the game console. The input units are arranged on the both sides of the LCD monitor.

A baseball video game is known as one of the games to be executed by the above-mentioned game devices. An example of the baseball video game is software for PlayStation® 2, “Jikkyo Powerful Pro-Yakyu 12” of Konami Digital Entertainment Co., Ltd. on sale in Jul. 14, 2005. In general, baseball video games are provided with a match-up mode. In the mode, a game player selects a baseball team, operates baseball player characters of the selected team, and competes with an opponent team for getting scores.

The match-up mode is to allow the baseball player character to perform a variety of actions when the game player gives a command of a motion of a baseball player character through a game controller while the baseball team selected by the game player takes an offensive/defensive position in a baseball match event. For example, a batter character swings a bat, and a pitcher character and a fielder character catching and throwing a ball.

For example, when a pitching command is given to the pitcher character, selection of pitch is performed and a command for starting pitching is given. Accordingly, a motion that a pitcher character releases the ball is displayed on a display monitor. Then, when a position of a catcher character's mitt is moved within a catcher window displayed on an upper part of the display, ball trajectory is determined. Then, when a predetermined period of time elapses, a ball is released.

On the other hand, when a command for hitting a ball is given to the batter character, a ball-hitting point of the batter character is determined by moving a ball-hitting cursor displayed on the display. Then, when the ball-hitting point (i.e., position of the ball-hitting cursor) is determined, a command for swinging the bat is given. Accordingly, a motion that the batter character swings the bat is displayed on the display monitor. Next, when the ball released by the pitcher character passed the ball-hitting point (i.e., position of the ball-hitting cursor) at a predetermined timing, the ball is hit by the bat.

As described above, the conventional baseball video game causes a baseball player character to perform a variety of motions when a variety of commands are executed. Accordingly, the conventional baseball video game is to progress the baseball match event in the match-up mode.

In the conventional baseball video game, a variety of commands are executed for a baseball character in a match event when a match-up mode is executed.

For example, in the conventional baseball game, a pitching trajectory that the pitcher character releases a ball is determined by moving a position of a catcher character's mitt displayed on the upper part of the display. The game player operating the batter character has been capable of predicting the pitching trajectory by tracking the position of the catcher character's mitt.

However, a recently produced baseball video game is provided with a specification that a catcher character's mitt (i.e., catcher window) is not displayed on the upper part of the display. This is referred to as “baseball video game without a catcher window”.

Therefore, if a game player having played the conventional baseball video game (e.g., Jikkyo Powerful Pro-Yakyu 12) plays the baseball video game without a catcher window, the game player is not capable of predicting a pitching trajectory with a position of a catcher character's mitt in the baseball video game without the catcher window. Accordingly, the following problem has arisen. It takes time for the game player to perform an operation for overlapping a ball-hitting cursor of a batter character with a ball-passage position (i.e., ball-reaching area). Additionally, the following problem has arisen. If a game player with experience of playing the conventional baseball video game plays a baseball video game without a catcher window, the game player tends to rush in pressing a button for causing a batter character to start a swing motion because it takes time for him/her to perform the operation for overlapping the ball-hitting cursor of the batter character with the ball-reaching area.

Because of this, when game players with experiences of playing the conventional baseball video game plays the baseball video game without the catcher window, they complain about an early/late swing of the batter character. Thus game providers have recently received the complains from game players.

Accordingly, aspects of the present invention have been created to solve the above-mentioned problems occurring in the conventional practice, and to reduce difference between a period of time required for arrival of a ball at a pitching trajectory and a period of time required for arrival of a bat at a contact-hitting position.

Generally, object of the present invention is to reduce difference between a period of time between when a second moving object released by a second character passes through a plane and when a first moving object moving in conjunction with a motion of a first character passes through the plane.

### SUMMARY OF THE INVENTION

A first aspect of the present invention relates to a game program. The game program is to cause a computer to realize a variety of functions. The computer is executing a game of displaying a first moving object and a second moving object on the image display unit. The first moving object moves in conjunction with a motion of a first character, and the second moving object is released by a second character. The variety of functions include:
(1) A predicted passage position recognition function for setting a predicted passage plane that the second moving object released by the second character passes by causing a control unit to recognize a coordinate for determining the predicted passage plane;
(2) A base arrival time setting function for setting base arrival time by causing the control unit to recognize the base arrival time, the base arrival time being stored in a storage unit, the base arrival time being set to a period of time elapsing since the first character starts performing a motion until the first moving object moving in conjunction with a motion of the first character arrives at the predicted passage plane;
(3) A second moving object display function for displaying the second moving object released by the second character on the image display unit with image data for the second moving object;
(4) A first moving object display function for displaying the first moving object moving in conjunction with a motion of the first character on the image display unit with image data for the first moving object by causing the control unit to issue a motion start command for causing the first character to perform a motion;
(5) An arrival time computation function for computing arrival time elapsing since the second moving object is released by the second character until the second moving object arrives at the predicted passage plane by causing the control unit to recognize velocity of the second moving object when the control unit issues the motion start command and distance from a position of the second moving object when the control unit issues the motion start command to the predicted passage plane; and
(6) A time difference reduction function for reducing difference between a period of time required for the arrival of the first moving object at the predicted passage plane and a period of time required for the arrival of the second moving object at the predicted passage plane by causing the control unit to execute processing of correcting the base arrival time for reducing absolute value of the difference between the base arrival time and the arrival time.

According to the game program, in the predicted passage position recognition function, the predicted passage plane is set by causing the control unit to recognize the coordinate for determining the predicted passage plane that the second moving object released by the second character passes. In the base arrival time setting function, base arrival time is set by causing the control unit to recognize the base arrival time stored in the storage unit. The base arrival time is set to a period of time elapsing since the first character starts performing a motion until the first moving object moving in conjunction with a motion of the first character arrives at the predicted passage plane. In the second moving object display function, the second moving object released by the second character is displayed on the image display unit with image data for the second moving object. In the first moving object display function, the first moving object moving in conjunction with the motion of the first character is displayed on the image display unit with image data for the first moving object by causing the control unit to issue the motion start command for causing the first character to perform the motion. In the arrival time computation function, arrival time elapsing since the second moving object is released by the second character until the second moving object arrives at the predicted passage plane is computed by causing the control unit to recognize velocity of the second moving object when the control unit issues the motion start command and distance from a position of the second moving object when the control unit issues the motion start command to the predicted passage plane. In the time difference reduction function, difference between a period of time required for the arrival of the first moving object at the predicted passage plane and the period of time required for the arrival of the second moving object at the predicted passage plane is reduced by causing the control unit to execute processing of correcting the base arrival time for reducing absolute value of the difference between the base arrival time and the arrival time.

For example, when a baseball video game is executed with the present game program, the predicted passage plane is set by causing the control unit to recognize the coordinate for determining the predicted passage plane that a ball released by the pitcher character passes. Then, base arrival time is set by causing the control unit to recognize the base arrival time elapsing since a batter character starts performing a swing motion until a bat moving in conjunction with the swing motion of the batter character arrives at the predicted passage plane. The base arrival time is stored in a storage unit. Then, the ball released by the pitcher character is displayed on the image display unit with image data for the ball. Next, the bat moving in conjunction with the swing motion of the batter character is displayed on the image display unit with the bat's image data by causing the control unit to issue a swing motion start command for causing the batter character to perform the swing motion. Then, arrival time elapsing since the ball is released by the pitcher character until the released ball arrives at the predicted passage plane is calculated by causing the control unit to recognize velocity of the ball when the control unit issues the swing motion start command and distance (arrival distance) from a position of the ball when the control unit issues the swing motion start command to the predicted passage plane. Subsequently, difference is reduced between the time required for the arrival of the bat at the predicted passage plane and the time required for the arrival of the ball at the predicted passage plane by causing the control unit to execute processing of correcting the base arrival time for reducing absolute value of difference between the base arrival time and the arrival time.

In this case, the arrival time when the control unit issues the swing motion start command is computed based on the velocity of the ball when the control unit issues the swing motion start command and the arrival distance when the control unit issues the swing motion start command. For example, it is possible to calculate the above-mentioned arrival time by causing the control unit to execute processing of dividing the arrival distance by velocity of the ball. The arrival time corresponds to the period of time elapsing since the batter character starts performing the swing motion until the ball arrives at the predicted passage plane. Then, the control unit executes processing of correcting the base arrival time for reducing absolute value of difference between the arrival time and the time (base arrival time) elapsing since the batter character starts performing the swing motion until the bat arrives at the predicted passage plane.

According to the first aspect of the present invention, with the above-mentioned configuration, the difference is reduced between the time required for the arrival of the bat at the predicted passage plane and the time required for the arrival of the ball at the predicted passage plane even if the batter character swings late/early. Accordingly, it is possible to ease the extent of a late/early swing. Generally, according to the first aspect of the present invention, it is possible to easily match the timing when the first moving object (i.e., bat) moving in conjunction with the motion of the first character (i.e., batter character) arrives at the plane and the timing when the second moving object (i.e., ball) released by the second character (i.e., pitcher character) arrives at the plane by reducing the difference between time required for passage of the first moving object through the predicted passage plane and time required for passage of the second moving object through the predicted passage plane.

A second aspect of the present invention relates to the game program according to the first aspect. In the game program, the control unit executes processing of correcting the base arrival time for reducing the base arrival time when the base arrival time is greater than the arrival time. Accordingly, the difference is reduced between the period of time required for the arrival of the first moving object at the predicted passage plane and the period of time required for the arrival of the second moving object at the predicted passage plane. The herein-mentioned processing is executed in the time difference reduction function.

For example, when a baseball video game is executed with the present game program, if time elapsing since the batter character starts performing the swing motion until the bat arrives at the predicted passage plane (i.e., base arrival time) is greater than time elapsing since the batter character starts performing a swing motion until the ball arrives at the predicted passage plane (i.e., arrival time), the control unit executes processing of correcting base arrival time for reducing the base arrival time. Accordingly, difference is reduced between the time required for the arrival of the bat at the predicted passage plane and the time required for the arrival of the ball at the predicted passage plane.

In this case, at the moment when the batter character starts performing the swing motion, a late swing of the batter character has already been determined (i.e., the base arrival time is greater than the arrival time). Accordingly, the control unit corrects the base arrival time for reducing the base arrival time. Then, absolute value of difference between the base arrival time and the arrival time is reduced. Accordingly, it is possible to reduce the difference between the time required for the arrival of the first moving object at the predicted passage plane and the time required for the arrival of the second moving object at the predicted passage plane.

As described above, according to the second aspect of the present invention, it is possible to ease the extent of a late swing by reducing the difference between the time required for the arrival of the bat at the predicted passage plane and the time required for the arrival of the ball at the predicted passage plane when the batter character swings late. Generally, according to the second aspect, it is possible to easily match a timing when a first moving object (i.e., bat) moving in conjunction with a motion of the first character (i.e., batter character) arrives at the plane and a timing when the second moving object (i.e., ball) released by a second character (i.e., pitcher character) arrives at the plane by reducing difference between the time required for passage of the first moving object through the predicted passage plane and the time required for passage of the second moving object through the predicted passage plane.

A third aspect of the present invention relates to the game program according to one of the first and second aspects. In the game program, the control unit executes processing of correcting the base arrival time in accordance with the velocity of the second moving object for reducing absolute value of the difference between the base arrival time and the arrival time. Accordingly, the difference is reduced between the period of time required for the arrival of the first moving object at the predicted passage plane and the period of time required for the arrival of the second moving object at the predicted passage plane. The herein-mentioned processing is executed in the time difference reduction function.

For example, when a baseball video game is executed with the present game program, the control unit executes processing of correcting base arrival time depending on velocity of the ball for reducing absolute value of difference between the period of time elapsing since the batter character starts performing the swing motion until the bat arrives at the predicted passage plane (i.e., base arrival time) and the period of time elapsing since the batter character starts performing a swing motion until the ball arrives at the predicted passage plane (i.e., arrival time). Accordingly, difference is reduced between the time required for the arrival of the bat at the predicted passage plane and the time required for the arrival of the ball at the predicted passage plane.

In this case, the base arrival time is corrected (i.e., reduced) by subtracting time depending on velocity of the ball (i.e., the time being set with a parameter “velocity of the ball”) from the base arrival time, for instance. For example, when velocity of the ball is fast, a large value (i.e., time depending on velocity of the ball) is subtracted from the base arrival time. Also, when the velocity of the ball is slow, a small value (i.e., time depending on velocity of the ball) is subtracted from the base arrival time. Accordingly, it is possible to effectively reduce absolute value of difference between the base arrival time and the arrival time. In other words, it is possible to effectively reduce difference between the time required for the arrival of the first moving object at the predicted passage plane and the time required for the arrival of the second moving object at the predicted passage plane.

As described above, according to the third aspect of the present invention, the time depending on velocity of the ball (time being set with a parameter “velocity of the ball”) is subtracted from the base arrival time. Therefore, it is possible to effectively ease the extent of a late/early swing. Generally, according to the third aspect, it is possible to easily match the timing when the first moving object (i.e., bat) moving in conjunction with a motion of the first character (i.e., batter character) arrives at the plane and the timing when the second moving object (i.e., ball) released by a second character (i.e., pitcher character) arrives at the plane by reducing difference between the time required for passage of the first moving object through the predicted passage plane and the time required for passage of the second moving object through the predicted passage plane.

A fourth aspect of the present invention relates to the game program according to one of the first to third aspects. The variety of functions further include:
(7) A first passage area setting function for setting a first passage area of the first moving object by causing the control unit to recognize a coordinate within the first passage area on the predicted passage plane that the first moving object moving in conjunction with a motion of the first character passes;
(8) A second passage area setting function for setting a second passage area of the second moving object by causing the control unit to recognize a coordinate within the second passage area on the predicted passage plane that the second moving object released by the second character passes;
(9) A first collide determination function for determining whether or not the first moving object and the second moving object temporally collide by causing the control unit to execute processing of comparing corrected base arrival time and the arrival time;
(10) A second collide determination function for determining whether or not the first moving object and the second moving object spatially collide by causing the control unit to determine whether or not the coordinate within the first passage area and the coordinate within the second passage area are matched; and
(11) A moving direction determination function for determining a moving direction of the second moving object in accordance with a result of comparison between the corrected base arrival time and the arrival time by causing the control unit to execute processing of comparing the corrected base arrival time and the arrival time when the first moving object and the second moving object temporally and spatially collide.

According to the game program, in the first passage area setting function, the first passage area of the first moving object is set by causing the control unit to recognize the coordinate within the first passage area on the predicted passage plane that the first moving object moving in conjunction with the motion of the first character passes. In the second passage area setting function, the second passage area of the second moving object is set by causing the control unit to recognize the coordinate within the second passage area on the predicted passage plane that the second moving object released by the second character passes. In the first collide determination function, it is determined whether or not the first moving object and the second moving object temporally collide by causing the control unit to execute processing of comparing the corrected base arrival time and the arrival time. In the second collide determination function, it is determined whether or not the first moving object and the second moving object spatially collide by causing the control unit to determine whether or not the coordinate within the first passage area and the coordinate within the second passage area are matched. In the moving direction determination function, a moving direction of the second moving object is determined in accordance with the result of the comparison between the corrected base arrival time and the arrival time by causing the control unit to execute processing of comparing the corrected base arrival time and the arrival time when the first moving object and the second moving object temporally and spatially collide.

For example, when a baseball video game is executed with the present game program, a contact-hitting cursor (i.e., first passage area) of the bat is set by causing the control unit to recognize the coordinate within the contact-hitting cursor on the predicted passage plane that the bat moving in conjunction with the motion of the batter character passes. Then, a ball-reaching area (i.e., second passage area) of the ball is set by causing the control unit to recognize the coordinate within the ball-reaching area on the predicted passage plane that the ball released by the pitcher character passes. Then, it is determined whether or not the bat and the ball temporally hit by causing the control unit to execute processing of comparing the corrected base arrival time and the arrival time. Next, it is determined whether or not the bat and the ball spatially hit by causing the control unit to determine whether or not a coordinate within the contact-hitting cursor and the coordinate within the ball-reaching area. Then, when the bat and the ball temporally and spatially hit, a moving direction of the ball is determined in accordance with the result of comparison between the corrected base arrival time and the arrival time by causing the control unit to execute processing of comparing the corrected base arrival time and the arrival time.

In this case, it is determined whether or not the bat and the ball temporally collide on the predicted passage plane by comparing the corrected base arrival time and the arrival time. On the other hand, it is determined whether or not the bat and the ball spatially collide by determining whether or not the contact-hitting cursor and the ball-reaching area are matched. When it is determined that the bat and the ball temporally and spatially collide, a moving direction of the ball is determined depending on the result of comparison between the corrected base arrival time and the arrival time. For example, when the bat hits the ball, a flying direction of the hit ball is determined depending on the value of difference between the period of time elapsing since the batter character starts performing a swing motion until the bat arrives at the predicted passage plate (i.e., base arrival time) and the period of time elapsing since the batter character starts performing a swing motion until the ball arrives at the predicted passage plane (i.e., arrival time).

As described above, according to the fourth aspect of the present invention, it is possible to determine the flying direction of the hit ball depending on the value of difference between the base arrival time and the arrival time while the extent of a late/early swing is eased. For example, when the value of difference between the corrected base arrival time and the arrival time is relatively small, the hit ball flies in a direction of the center field. On the other hand, when the value of difference between the corrected base arrival time and the arrival time is relatively large, the hit ball flies in a direction of the right/left field even if the extent of the late/early swing is eased. Thus, even when the extent of a late/early swing is eased, the hit ball is configured not to fly in a direction of the center field. Accordingly, even when the above-mentioned processing of the present invention is executed in the baseball video game, it is possible to make the game player play the game without having feeling that something is wrong.

Generally, according to the fourth aspect, the moving direction of the second moving object is determined depending on the result of comparison between the time required for passage of a first moving object (i.e., bat) moving in conjunction with a motion of a first character (i.e., batter character) through the predicted passage plane and the time required for passage of the second moving object (i.e., ball) released by the second character (i.e., pitcher character) through the predicted passage plane. Thus, when functions of the present invention are executed, it is possible to make the game player play the game without having feeling that something is wrong.

A fifth aspect of the present invention relates to the game program according to one of the first to fourth aspects. In the game program, the base arrival time is set by causing the control unit to recognize the base arrival time having a predetermined range of time. The range (a predetermined range of time) for setting the base arrival time has the minimum value and the maximum value. The minimum value is set by subtracting predetermined adjustment time from the predetermined base time. On the other hand, the maximum value is set by adding the predetermined adjustment time to the predetermined base time. Also, the adjustment time is set for adjusting variation in time when the first character starts performing a motion.

For example, when a baseball video game is executed with the present game program, the period of time elapsing since the batter character starts performing the swing motion until the bat arrives at the predicted passage plane (i.e., base arrival time) has a predetermined range. The predetermined range is provided for dealing with variation in instruction timing when the batter character is instructed to start performing the swing motion.

For example, when difference becomes large between the base arrival time and the arrival time when the game player instructs start of the swing motion, in other words, only when timing of starting the swing motion greatly deviates from the timing of hitting the ball in a direction of the center field, it is possible to cause the control unit to execute processing of adjusting the base arrival time.

In other words, if the control unit is caused to execute processing of adjusting the base arrival time when the timing of the swing motion slightly deviates from the timing of hitting the ball in a direction of the center field, late-swing timing may become early-swing timing in some cases and vice versa. Accordingly, the hit ball flies in a direction different from a game player's assumption. Because of this, a game player may have feeling that something is wrong. However, according to the fifth aspect of the present invention, the above-mentioned variation in timing is not caused by providing the base arrival time with a predetermined range. Therefore, it is possible to prevent the game player from having the above-mentioned uncomfortable feeling arising from variation in timing.

Generally, according to the fifth aspect, a predetermined range is set for the time required for passage of the first moving object (i.e., bat) moving in conjunction with the motion of the first character (i.e., batter character) the a predicted passage plane. Accordingly, the game player is of playing the game without having feeling that something is wrong.

A sixth aspect of the present invention is the game program according to one of the first to fifth aspects. The variety of functions further include:
(12) A special ability determination function for determining whether or not the first character has a special ability by causing the control unit to determine whether or not special ability data corresponding to the special ability of the first character is set.

In the special ability determination function of the game program, it is determined whether or not the first character has the special ability by causing the control unit to determine whether or not special ability data corresponding to the special ability of the first character is set. Furthermore, in the time difference reduction function, the difference is reduced between the period of time required for the arrival of the first moving object at the predicted passage plane and the period of time required for the arrival of the second moving object at the predicted passage plane by causing the control unit to execute processing of correcting the base arrival time for reducing absolute value of the difference between the base arrival time and the arrival time when the first character has the special ability.

For example, when a baseball video game is executed with the present game program, the control unit determines whether or not special ability data corresponding to the special ability of the batter character is set. Accordingly, it is determined whether or not the batter character has the special ability. When the batter character has the special ability, the control unit executes processing of correcting the base arrival time for reducing absolute value of difference between the base arrival time and the arrival time. Accordingly, difference is reduced between the time required for the arrival of the bat at the predicted passage plane and the time required for the arrival of the ball at the predicted passage plane.

In this case, only when the batter character has the special ability, correction is performed for reducing difference between the time required for the arrival of the bat at the predicted passage plane and the time required for the arrival of the ball at the predicted passage plane. Therefore, if a game player wants to ease the extent of the late/early swing when the batter character swings late/early, the game player needs to obtain the special ability of the batter character. In other words, the game player is capable of easing the extent of the late/early swing only after obtaining a special ability of the batter character.

Generally, when special ability data corresponding to the special ability is allocated to the first character, it is possible to reduce difference between the time required for passage of the first moving object (i.e., bat) moving in conjunction with the motion of the first character (i.e., batter character) through the predicted passage plane and the time required for passage of the second moving object (i.e., ball) released by the second character (i.e., pitcher character) through the predicted passage plane. Accordingly, only when the special ability data is allocated to the first character, it is possible to easily match the timing when the first moving object arrives at the plane and the timing when the second moving object arrives at the plane.

A seventh aspect of the present invention relates to a game device. The game device is capable of executing the game in which a first moving object and a second moving object are displayed on an image display unit. The first moving object moves in conjunction with a motion of a first character. The second moving object is released by a second character. The game device includes predicted passage position recognition means, base arrival time setting means, second moving object display means, first moving object display means, arrival time computation means, and time difference reduction means. The predicted passage position recognition means is for setting a predicted passage plane that the second moving object released by the second character passes by causing a control unit to recognize a coordinate for determining the predicted passage plane. The base arrival time setting means is for setting base arrival time by causing the control unit to recognize the base arrival time. The base arrival time is stored in a storage unit. The base arrival time is set to a period of time elapsing since the first character starts performing a motion until the first moving object moving in conjunction with a motion of the first character arrives at the predicted passage plane. The second moving object display means is for displaying the second moving object released by the second character on the image display unit with image data for the second moving object. The first moving object display means is for displaying the first moving object moving in conjunction with a motion of the first character on the image display unit with image data for the first moving object by causing the control unit to issue a motion start command for causing the first character to perform the motion. The arrival time computation means is for computing arrival time elapsing since the second moving object is released by the second character until the second moving object arrives at the predicted passage plane by causing the control unit to recognize velocity of the second moving object when the control unit issues the motion start command and distance from a position of the second moving object when the control unit issues the motion start command to the predicted passage plane. The time difference reduction means is for reducing difference between the period of time required for the arrival of the first moving object at the predicted passage plane and the period of time required for the arrival of the second moving object at the predicted passage plane by causing the control unit to execute processing of correcting the base arrival time for reducing absolute value of the difference between the base arrival time and the arrival time.

An eighth aspect of the present invention relates to a game control method. The game control method includes allowing a computer to control a game of displaying a first moving object and a second moving object on the image display unit. The first moving object moves in conjunction with a motion of the first character. The second moving object is released by a second moving object. The game control method includes the following steps: a step of setting a predicted passage plane that the second moving object released by the second character passes by causing a control unit to recognize a coordinate for determining the predicted passage plane; a step of setting base arrival time by causing the control unit to recognize the base arrival time, the base arrival time being stored in a storage unit, the base arrival time being set to a period of time elapsing since the first character starts performing a motion until the first moving object moving in conjunction with a motion of the first character arrives at the predicted passage plane; a step of displaying the second moving object released by the second character on the image display unit with image data for the second moving object; a step of displaying the first moving object moving in conjunction with a motion of the first character on the image display unit with image data for the first moving object by causing the control unit to issue a motion start command for causing the first character to perform a motion; a step of computing arrival time elapsing since the second moving object is released by the second character until the second moving object arrives at the predicted passage plane by causing the control unit to recognize velocity of the second moving object when the control unit issues the motion start command and distance from a position of the second moving object when the control unit issues the motion start command to the predicted passage plane; and a step of reducing difference between the period of time required for the arrival of the first moving object at the predicted passage plane and the period of time required for the arrival of the second moving object at the predicted passage plane by causing the control unit to execute processing of correcting the base arrival time for reducing absolute value of the difference between the base arrival time and the arrival time.

According to the present invention, it is possible to easily match a timing of arrival of the first moving object at a predicted passage plane and a timing of arrival of the second moving object at the predicted passage plane by reducing difference between the period of time elapsing until the second moving object (i.e., ball) released by the second character (i.e., pitcher character) passes through the predicted passage plane and the period of time elapsing until the first moving object (i.e., bat) moving in conjunction with the motion of a first character (i.e., batter character) passes through the predicted passage plane. Furthermore, according to the present invention, it is possible to determine a moving direction of the second moving object in accordance with a result of comparison between the period of time elapsing until the second moving object released by the second character passes through the predicted passage plane and the period of time elapsing until the first moving object moving in conjunction with the motion of the first character passes through the predicted passage plane. Accordingly, a game player is playing a game without having a feeling that something is wrong.

### BRIEF DESCRIPTION OF THE DRAWINGS

Referring now to the attached drawings which form a part of this original disclosure:

FIG. 1 is a block diagram for illustrating basic configurations of a video game device in accordance with an embodiment of the present invention;

FIG. 2 is a functional block diagram for illustrating an example of the video game device;

FIG. 3 is a diagram for illustrating a baseball match screen (before pitching);

FIG. 4 is a diagram for illustrating a baseball match screen (after pitching);

FIG. 5 is a diagram for illustrating arrival time elapsed until a ball arrives at a predicted passage plane;

FIG. 6 is a diagram for illustrating a setting of a ball flying direction

FIG. 7 is a flowchart for illustrating outline of the entire baseball video game;

FIG. 8A is a flowchart for illustrating a part of a warm-up system in a baseball video game;

FIG. 8B is a flowchart for illustrating a part of the warm-up system in the baseball video game;

FIG. 8C is a flowchart for illustrating a part of the warm-up system in the baseball video game; and

FIG. 8D is a flowchart for illustrating a part of the warm-up system in the baseball video game.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Configuration and Operation of Game Device

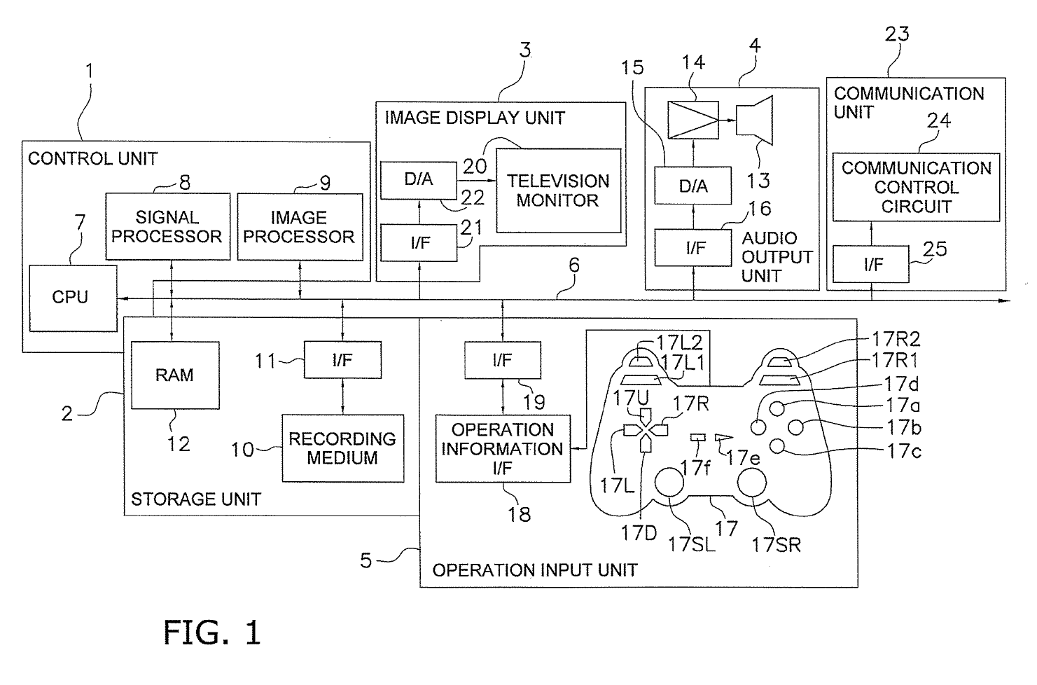

FIG. 1 shows the basic configuration of a game device in accordance with an embodiment of the present invention. As an example of a video game device, a home video game device will be hereinafter explained. The home video game device includes a home video game console and a home television set. A recording medium 10 is allowed to be loaded in the home video game console. Game data is arbitrarily read out of the recording medium 10 and a game is executed. The content of the game executed herewith is displayed on the home television set.

The game system of the home video game device is made up of a control unit 1, a storage unit 2, an image display unit 3, an audio output unit 4, and an operation input unit 5. These units are connected to each other through a bus 6. This bus 6 includes an address bus, a data bus, a control bus, and the like. Here, the control unit 1, the storage unit 2, the audio output unit 4, and the operation input unit 5 are included in the home video game console of the home video game device, and the image display unit 3 is included in the home television set.

The control unit 1 is provided for mainly controlling the progress of the entire game based on the game program. For example, the control unit 1 is made up of a CPU (Central Processing Unit) 7, a signal processor 8, and an image processor 9. The CPU 7, the signal processor 8, and the image processor 9 are connected to each other through the bus 6. The CPU 7 interprets a command from a game program and executes a variety of data processing and data control. For example, the CPU 7 commands the signal processor 8 to provide the image data to the image processor. The signal processor 8 mainly executes computations in the three-dimensional space, position conversion computations from the three-dimensional space to a virtual three-dimensional space, light source computation processing, and data generation and data processing of image data and audio data. The image processor 9 mainly executes processing of writing image data on a RAM (Random Access Memory) 12 based on the computation results and processing results of the signal processor 8. Note that the image data written in the RAM 12 will be subsequently rendered.

The storage unit 2 is provided mainly for storing the program data, various types of data used for the program data, and the like. For example, the storage unit 2 is made up of the recording medium 10, an interface circuit 11, and the RAM 12, for instance. The interface circuit 11 is connected to the recording medium 10. The interface circuit 11 and the RAM 12 are connected through the bus 6. The recording medium 10 stores program data of the operation system, game data made up of image data, audio data, and various types of program data, and the like. For example, the recording medium 10 is a ROM (Read Only Memory) cassette, an optical disk, a flexible disk, or the like. The program data of the operating system, the game data, and the like are stored in this recording medium 10. Note that a card memory is also included in a category of the recording medium 10. The card memory is mainly used for storing various game parameters at the point of interruption of the game. The RAM 12 is used for temporarily storing various types of data read out of the recording medium 10, and for temporarily recording the processing results of the control unit 1. The RAM 12 stores address data as well as various types of data. Note that the address data indicates the memory location of various types of data. The RAM 12 is allowed to specify an arbitrary address and read/write data from/onto the address.

The image display unit 3 is provided for mainly outputting various types of image data as an image. For example, the various types of image data include the image data written onto the RAM 12 by the image processor 9 and the image data read out of the recording medium 10. For example, the image display unit 3 is made up of a television monitor 20, an interface circuit 21, a D/A converter (Digital-to-Analog converter) 22. The D/A converter 22 is connected to the television monitor 20, and the interface circuit 21 is connected to the D/A converter 22. In addition, the bus 6 is connected to the interface circuit 21. Here, the image data is provided to the D/A converter 22 through the interface circuit 21, and is converted into an analog image signal in the D/A converter 22. Then, the analog image signal is outputted to the television monitor 20 as an image.

Here, the image data includes polygon data, texture data, and the like. The polygon data is the coordinate data of vertices forming a polygon. The texture data is used for setting texture with respect to the polygon. The texture data is made up of texture specifying data and texture color data. The texture specifying data is used for associating the polygon and the texture, and the texture color data is used for specifying the texture color. Here, the polygon data and the texture data are associated with polygon address data and texture address data, respectively. The polygon address data and the texture address data include storage locations of the polygon data and the texture data, respectively. As to the image data of this type, the signal processor 8 performs coordinate conversion and perspective projection conversion with respect to the polygon data in the three-dimensional space (i.e., the three-dimensional polygon data) specified by the polygon address data based on the displacement data and the rotation amount data of the screen itself (i.e., point of sight). Accordingly, the polygon data is converted into the polygon data in the two-dimensional space (i.e., the two-dimensional polygon data). Then, a polygon outline is constituted with a plurality of two-dimensional polygon data, and texture data specified by the texture address data is written onto the internal area of the polygon. Thus, it is possible to express a variety of objects (i.e., characters) made by applying texture to each polygon.

The audio output unit 4 is provided mainly for outputting the audio data read out of the recording medium 10 as audio. For example, the audio output unit 4 is made up of a speaker 13, an amplifier circuit 14, a D/A converter 15, and an interface circuit 16. The amplifier circuit 14 is connected to the speaker 13. The D/A converter 15 is connected to the amplifier circuit 14. The interface circuit 16 is connected to the D/A converter 15. In addition, the bus 6 is connected to the interface circuit 16. Here, the audio data is provided to the D/A converter 15 through the interface circuit 16 and is converted into an analog audio signal. The analog audio signal is amplified by the amplifier circuit 14, and is outputted from the speaker 13 as audio. For example, ADPCM (Adaptive Differential Pulse Code Modulation) data, PCM (Pulse Code Modulation) data, and the like are included in the category of the audio data. With regards to the ADPCM data, it is possible to output the audio from the speaker 13 with almost the same type of the above-mentioned processing method. With regards to the PCM data, if the PCM data is converted into the ADPCM data in the RAM 12, it is possible to output the audio from the speaker 13 with almost the same type of the above-mentioned processing method.

The operation input unit 5 is mainly made up of a controller 17, an operation information interface circuit 18, and an interface circuit 19. The operation information interface circuit 18 is connected to the controller 17, and the interface circuit 19 is connected to the operation information interface circuit 18. In addition, the bus 6 is connected to the interface circuit 19.

The controller 17 is an operation unit used by the video game player for the purpose of inputting various operation commands, and transmits operation signals to the CPU 7 according to the video game player's operation. The controller 17 is provided with a first button 17a, a second button 17b, a third button 17c, a fourth button 17d, an up key 17U, a down key 17D, a left key 17L, a right key 17R, a L1 button 17L1, a L2 button 17L2, a R1 button 17R1, a R2 button 17R2, a start button 17e, a select button 17f, a left stick 17SL, and a right stick 17SR.

For example, the up key 17U, the down key 17D, the left key 17L, and the right key 17R are used for providing the CPU 7 with a command to cause the characters and a cursor to move up, down, left, and right on the screen of the television monitor 20.

For example, the start button 17e is used for commanding the CPU 7 to load the game program from the recording medium 10, and for suspending the running game program.

For example, the select button 17f is used for commanding the CPU 7 to execute various selections with respect to the game program loaded from the recording medium 10.

The left stick 17SL and the right stick 17SR are stick-shaped controllers with approximately the same configuration as a so-called joystick. This stick-shaped controller includes an upright stick. The stick is allowed to lean from the upright position to 360-degree directions including front, back, left, and right directions, centering around the fulcrum. The left and right sticks 17SL and 17SR respectively transmit their positional information as an operation signal to the CPU 7 through the operation information interface circuit 18 and the interface circuit 19. Here, their upright positions are defined as the origin of the x-y coordinate, and their positions are accordingly expressed with values in the x-y coordinate. When the left and right sticks 17SL and 17SR are leaned, their positions are determined depending on their leaned directions and angles.

Various functions are allocated to the first button 17a, the second button 17b, the third button 17c, the fourth button 17d, the L1 button 17L1, the L2 button 17L2, the R1 button 17R1, and the R2 button 17R2 depending on the game program to be loaded from the recording medium 10.

Here, excluding the left and right sticks 17SL and 17SR, the buttons and the keys provided in the controller 17 function as ON/OFF switches. Specifically, they are switched to an on-state when pressed from the neutral position by the external pressure. On the other hand, when the pressure is released, they return to the neutral positions and are switched to an off-state.

The general operations of the above-configured home video game device will be hereinafter explained. When a power switch (not illustrated in the figure) is turned on and the game system 1 is powered on, the CPU 7 reads out image data, audio data, and program data from the recording medium 10 based on the operating system stored in the recording medium 10. All or part of the read-out data including the image data, the audio data, and the program data are stored in the RAM 12. Then, the CPU 7 issues commands for data stored in the RAM 12 (e.g., the image data and the audio data) based on the program data stored in the RAM 12.

With regards to the image data, the signal processor 8 firstly performs a variety of computations (e.g., positional computation and light source computation for a character in the three-dimensional space) based on the command from the CPU 7. Next, the image processor 9 executes a variety of processing (e.g., processing for writing the image data (to be rendered) onto the RAM 12) based on the computation results by the signal processor 8. Then, the image data written onto the RAM 12 is provided to the D/A converter 22 through the interface circuit 21. Here, the image data is converted into an analog image signal by the D/A converter 22. The image data is subsequently provided to the television monitor 20 and is displayed as an image.

With regards to the audio data, the signal processor 8 firstly executes processing to generate and process audio data based on the command from the CPU 7. Here, a variety of processing (e.g., pitch conversion, noise addition, envelope setting, level setting, and reverb addition) are executed for the audio data. Next, the audio data is outputted from the signal processor 8, and is provided to the D/A converter 15 through the interface circuit 16. Here, the audio data is converted into an analog audio signal. Then, the audio data is outputted as the audio from the speaker 13 through the amplifier circuit 14.

### Summary of Variety of Processing in Game Device

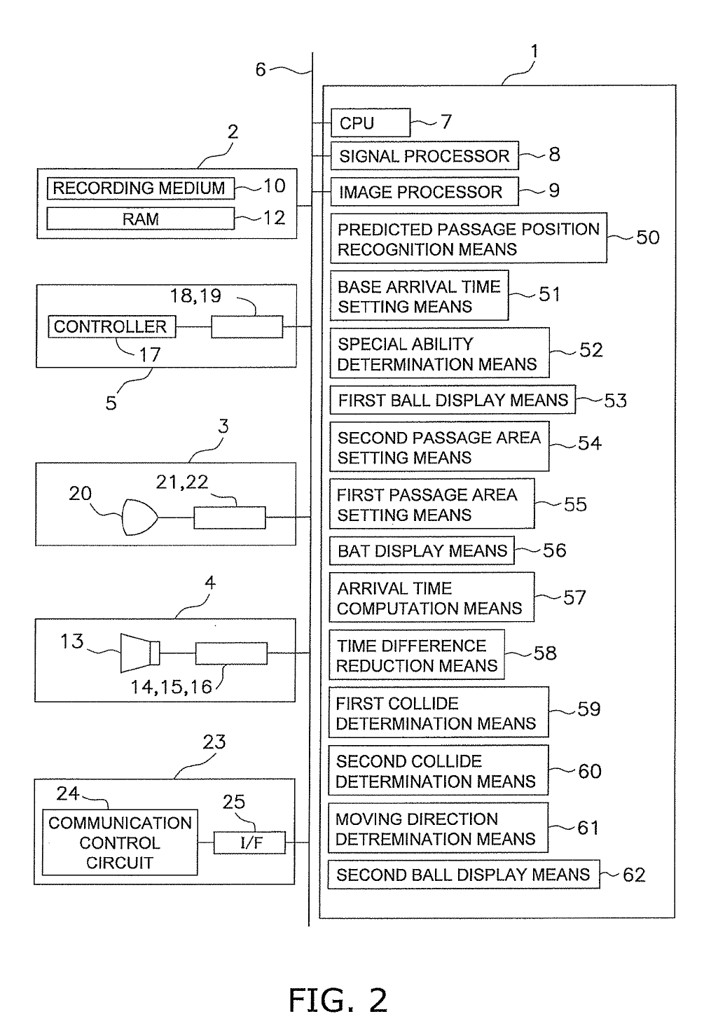

For example, a baseball video game is executed in the present game device. The present game device is capable of displaying a bat object (hereinafter simply referred to as “bat”) and a ball object (hereinafter simply referred to as “ball”) on the television monitor 20. Here, the bat is moved in conjunction with a swing motion of a batter character. The ball is released by a pitcher character. FIG. 2 is a functional block diagram for illustrating functions playing major roles in the present invention.

Predicted passage position recognition means 50 has a function for setting a predicted passage plane by causing the CPU 7 to recognize a coordinate for determining the predicted passage plane that the ball released by the pitcher character passes.

In the means, the predicted passage plane is set by causing the CPU 7 to recognize the coordinate for determining the predicted passage plane that the ball released by the pitcher character passes. The predicted passage plane is a plane that the ball released by the pitcher character passes. The predicted passage plane is arranged above the center of mass of the home plate. Additionally, the predicted passage plane is perpendicular to a line connecting the center of mass of the home plate and that of the pitcher's plate.

Here, when the center of mass of the home plate is defined as the origin, a direction from the center of mass of the home plate to that of the pitcher's plate is defined as a y-direction. Additionally, an upper perpendicular direction from the center of mass of the home plate is defined as a z-direction. Also, a direction extending from the center of mass of the home plate to be perpendicular to the y and z directions is defined as an x-direction. Based on the definition, an x-z plane is defined above the center of mass of the home plate. The x-z plane corresponds to the predicted passage plane. In other words, the predicted passage plane is herein set by causing the CPU 7 to recognize the coordinate of the center of mass of the home plate.

Base arrival time setting means 51 has a function of setting base arrival time by causing the CPU 7 to recognize the base arrival time. The base arrival time is stored in the storage unit 2. Additionally, the base arrival time is set to a period of time elapsing since the batter character starts a swinging motion until the bat moving in conjunction with the swing motion of the batter character arrives at the predicted passage plane.

In the means, the base arrival time is set. As described above, the base arrival time is the period of time since the start of a batter character's swing motion until the arrival of the bat moving in conjunction with the batter character's swing motion at the predicted passage plane. The base arrival time is preliminarily determined in the game program. When the game program is loaded, the base arrival time is provided from the recording medium 10 to the RAM 12. Then, the base arrival time is stored in the RAM 12. The base arrival time is set by causing the CPU 7 to recognize it.

The base arrival time has a predetermined range. A predetermined adjustment time is subtracted from a predetermined base time, and the obtained value is used as the minimum value of the predetermined range. Additionally, the predetermined adjustment time is added to the predetermined base time, and the obtained value is used as the maximum value of the predetermined range. The adjustment time is set for adjusting subtle variation in time when the batter character starts the swing motion. The above-mentioned base time and adjustment time are preliminarily determined in the game program. When the game program is loaded, they are provided from the recording medium 10 to the RAM 12 and are stored in the RAM 12. The base arrival time is set by causing the CPU 7 to recognize the base arrival time with the above-mentioned predetermined range.

Special ability determination means 52 has a function of determining if the batter character has a special ability by causing the CPU 7 to determine whether or not special ability data corresponding to a special ability of the batter character is set.

In the means, it is determined whether or not the batter character has the special ability by causing the CPU 7 to determine whether or not special ability data corresponding to the special ability of the batter character is set.

The following is a case where the CPU 7 controls each batter character by assigning a unique identification number ID to each batter character. In this case, the CPU 7 controls the special ability of each batter character with special ability data TD (ID).

For example, when the batter character has the special ability, the CPU 7 assigns number “1” to the special ability data TD (ID) of the batter character. Also, when the batter character does not have the special ability, the CPU 7 assigns number “0” to the special ability data TD (ID) of the batter character.

In this case, it is determined whether or not the batter character has the special ability by causing the CPU 7 to determine whether or not value of the special ability data TD (ID) of the batter character is equal to number “1”. In other words, it is possible to cause the CPU 7 to control whether or not the batter character has the special ability with the special ability data TD (ID).

First ball display means 53 has a function of displaying the ball released by the pitcher character on the television monitor 20 with ball's image data.

In the means, the ball released by the pitcher character is displayed on the television monitor 20 with the ball's image data.

For example, when the CPU 7 issues a pitching command to the pitcher character based on an input signal from the controller 17, the pitcher character starts a pitching motion and then releases the ball. Also, when the CPU 7 issues the pitching command to the pitcher character based on the artificial intelligence (AI) program, the pitcher character starts the pitching motion and then releases the ball. Accordingly, the ball released by the pitcher character is displayed on the television monitor 20 with the ball's image data.

For example, the above-mentioned pitching command includes a pitch instruction command, a pitching start command, a pitching trajectory instruction command, and a ball release command. The pitch instruction command is issued when a pitch by the pitcher character is instructed. The pitching start command is issued when the start of the pitching motion of the pitcher character is instructed. The pitching trajectory instruction command is issued when a position of the catcher character's mitt is determined within a character window displayed on the upper part of the screen. The ball release command is used for causing the pitcher character to release the ball. The CPU 7 issues the above-mentioned commands based on the input signal from the controller 17 or the AI program.

Second passage area setting means 54 has a function of setting a ball-reaching area by causing the CPU 7 to recognize a coordinate within the ball-reaching area. The ball-reaching area exists on the predicted passage plane, and the ball released by the pitcher character passes through it.

In the means, the ball-reaching area of the ball is set. The ball-reaching area is used for preliminarily informing the game player of a passage position of the ball released by the pitcher character. The ball-reaching area of the ball is circularly displayed on the predicted passage plane.

Specifically, in the means, when the pitching command is issued based on the input signal from the controller 17 or the AI program, the CPU 7 recognizes a coordinate indicating a predicted passage position of the ball on the predicted passage plane (i.e., a position of the ball-reaching area). Thus, the position of the ball-reaching area is determined. When a position of the ball-reaching area is determined, the CPU 7 subsequently recognizes a coordinate within the ball-reaching area. Thus, the position and a range of the ball-reaching area are set.

First passage area setting means 55 has a function of setting a contact-hitting cursor of the bat by causing the CPU 7 to recognize a coordinate within the contact-hitting cursor on the predicted passage plane. The bat is moves in conjunction with the swing motion of the batter character, and is passing through the contact-hitting cursor.

In the means, the contact-hitting cursor of the bat is set. The contact-hitting cursor is an area on the predicted passage plane through which the bat passes when the bat moves in conjunction with the swing motion of the batter character. For example, the contact-hitting cursor shows the area on the predicted passage plane that the batter character is capable of hitting the ball when the batter character performs the swing motion. In this case, two kinds of contact-hitting cursors are prepared. The contact-hitting cursors have different sizes. The sizes of the contact-hitting cursors are preliminarily determined in the game program. The contact-hitting cursors are approximately elliptically displayed on the predicted passage plane of the ball.

Specifically, in the means, a position of the contact-hitting cursor is determined by causing the CPU 7 to recognize a coordinate indicating the position of the contact-hitting cursor on the predicted passage plane based on a movement command corresponding to an input signal from the controller 17 or the movement command from the AI program. When the position of the contact-hitting cursor is thus set, the CPU 7 recognizes the coordinate within the contact-hitting cursor on the predicted passage plane. In this way, the position and an area (i.e., range) of the contact-hitting cursor are set.

Bat display means 56 has a function of displaying the bat moving in conjunction with the swing motion of the batter character on the television monitor 20 with bat's image data by causing the CPU 7 to issue a swing start command for causing the batter character to perform the swing motion.

In the means, the CPU 7 is caused to issue the swing motion start command for causing the batter character to perform the swing motion, and the bat moving in conjunction with the swing motion of the batter character is displayed on the television monitor 20 with bat's image data.

For example, when the CPU 7 issues the swing motion start command with respect to the batter character based on an input signal from the controller 17, the batter character starts the swing motion. Also, when the CPU 7 issues the swing motion start command with respect to the batter character based on the AI program, the batter character starts the swing motion. Accordingly, a series of swing motions of the batter character are displayed on the television monitor 20 with the batter character's image data. Simultaneously, the bat moving in conjunction with the swing motion of the batter character is displayed on the television monitor with the bat's image data.

Arrival time computation means 57 has a function of computing a period of time elapsing since a ball is released by the pitcher character until the ball arrives at the predicted passage plane by causing the CPU 7 to recognize velocity of the ball when the CPU 7 issues the swing motion start command and distance from a position of the ball when the CPU 7 issues the swing motion start command to the predicted passage plane. Here, the period of time elapsing since the ball is released by the pitcher character until the ball arrives at the predicted passage plane is also referred to as “arrival time”.

In the means, the period of time (i.e., arrival time) elapsing since the ball is released by the pitcher character until the ball arrives at the predicted passage plane is computed by causing the CPU 7 to recognize velocity of the ball when the CPU 7 issues the swing motion start command and distance from the position of the ball when the CPU 7 issues the swing motion start command to the predicted passage plane.

For example, when the CPU 7 issues the swing motion start command, the CPU 7 recognizes velocity of the ball at this time and distance from the position of the ball at this time to the predicted passage plane. Here, the distance from the position of the ball when the CPU 7 issues the swing motion start command to the predicted passage plane is also referred to as “arrival distance”. Then, the arrival time is computed based on the velocity of the ball and the arrival distance of the ball herein recognized by the CPU 7. Specifically, the arrival time is computed by causing the CPU 7 to execute processing of dividing the ball's arrival distance recognized by the CPU 7 by the ball's velocity.

Time difference reduction means 58 has a function of reducing difference between the period of time required for arrival of the bat at the predicted passage plane and the period of time required for arrival of the ball at the predicted passage plane by causing the CPU 7 to execute processing of correcting base arrival time for reducing absolute value of difference between the base arrival time and the arrival time.

In the means, difference is reduced between the period of time required for the arrival of the bat at the predicted passage plane and the period of time required for the arrival of the ball at the predicted passage plane by causing the CPU 7 to execute processing of correcting the base arrival time for reducing absolute value of difference between the base arrival time and the arrival time.

In this case, difference is reduced between the period of time required for the arrival of the bat at the predicted passage plane and the period of time required for the arrival of the ball at the predicted passage plane by causing the CPU 7 to execute processing of correcting the base arrival time for reducing the base arrival rime when the base arrival time is greater than the arrival time.

For example, the base arrival time and the arrival time are compared by causing the CPU 7 to determine whether or not the base arrival time is greater than the arrival time. When the CPU 7 determines that the base arrival time is greater than the arrival time, the CPU 7 executes processing of subtracting correction time from the base arrival time for correcting the base arrival time. Accordingly, difference is reduced between the period of time required for the arrival of the bat at the predicted passage plane and the period of time required for the arrival of the ball at the predicted passage plane.

The herein-used correction time is preliminarily determined in the game program. When the game program is loaded, the correction time is provided from the recording medium 10 to the RAM 12, and is stored in the RAM 12.

In the after-mentioned embodiment of the present invention, the correction time is constant. However, the correction time may be a variable. For example, when velocity of the ball is set to “V_BALL” and the correction time is set to a value to change in accordance with the velocity V_BALL, the correction time may be expressed as “MT (V_BALL)”. When the velocity V_BALL has a large value, the correction time MT (V_BALL) is set to have a large value. On the other hand, when the velocity V_BALL has a small value, the correction time MT (V_BALL) is set to have a small value. Accordingly, it is possible to effectively reduce difference between the period of time required for the arrival of the bat at the predicted passage plane and the period of time required for the arrival of the ball at the predicted passage plane.

First collide determination means 59 has a function of determining whether or not the bat and the ball temporally collide by causing the CPU 7 to execute processing of comparing the corrected base arrival time and the arrival time.

In the means, it is determined whether or not the bat and the ball temporally collide by causing the CPU 7 to execute processing of comparing the corrected base arrival rime and the arrival time.

For example, in the means, the CPU 7 determines whether or not difference between the corrected base arrival time and the arrival time falls in a predetermined range of time. When the CPU 7 determines that difference between the corrected base arrival time and the arrival time falls in the predetermined range of time, it is determined that the bat and the ball temporally collide.

The herein-used predetermined range of time is preliminarily determined in the game program. When the game program is loaded, the maximum value and the minimum value of the predetermined range of time are provided from the recording medium 10 to the RAM 12, and are stored in the RAM 12. Additionally, medium of the predetermined range of time is set to “0 (zero)”. The medium is computed by adding the maximum value and the minimum value of the predetermined range of time and then multiplying the obtained value by “0.5”.

Second collide determination means 60 has a function of determining whether or not the bat and the ball spatially collide by causing the CPU 7 to determine whether or not if an overlapping area exists between an area within the contact-hitting cursor and the ball-reaching area of the ball.

In the means, it is determined whether or not the bat and the ball spatially collide by causing the CPU 7 to determine whether or not the overlapping area exists between the area within the contact-hitting cursor and the ball-reaching area of the ball.

For example, in the means, it is determined whether or not the bat and the ball spatially collide by causing the CPU 7 to determine whether or not a coordinate within the contact-hitting cursor is matched with a coordinate within the ball-reaching area of the ball.

Movement direction determination means 61 has a function of determining a moving direction of the ball in accordance with a result of comparison between the corrected base arrival time and the arrival time by causing the CPU 7 to execute processing of comparing the corrected base arrival time and the arrival time when the bat and the ball temporally and spatially collide.

In the means, when the bat and the ball temporally and spatially collide, the CPU 7 is caused to execute processing of comparing the corrected base arrival time and the arrival time, and the moving direction of the ball is determined in accordance with the result of the comparison.

For example, in the means, when the bat and the ball temporally and spatially collide, the CPU 7 determines that difference between the corrected base arrival time and the arrival time falls in the predetermined range of time and simultaneously the coordinate within the contact-hitting cursor and the coordinate within the ball-reaching area are matched. In other words, when the bat and the ball temporally and spatially collide, the ball is hit back by the bat. In this case, the moving direction of the ball is determined in accordance with difference between the corrected base arrival time and the arrival time.

In this case, when difference between the corrected base arrival time and the arrival time (i.e., a value computed by subtracting the arrival time from the corrected base arrival time) is a negative value and simultaneously gets smaller, the moving direction of the ball is set to be proportionally close to a direction of the left field or a direction of the foul zone on the third base side. On the other hand, when the value computed by subtracting the arrival time from the corrected base arrival time is a positive value and simultaneously gets larger, the moving direction of the ball is set to be proportionally close to a direction of the right field or a direction of the foul zone on the first base side. Furthermore, when difference between the corrected base arrival time and the arrival time gets closer to “0 (zero)”, the moving direction of the ball is set to be proportionally close to a direction of the center field.

Second ball display means 62 has a function of displaying the ball hit back by the batter character on the television monitor 20 with the ball's image data. In the means, the ball hit back by the batter character is displayed on the television monitor 20 with the ball's image data.

### Summary of Swing Speed Correction System in Baseball Video Game

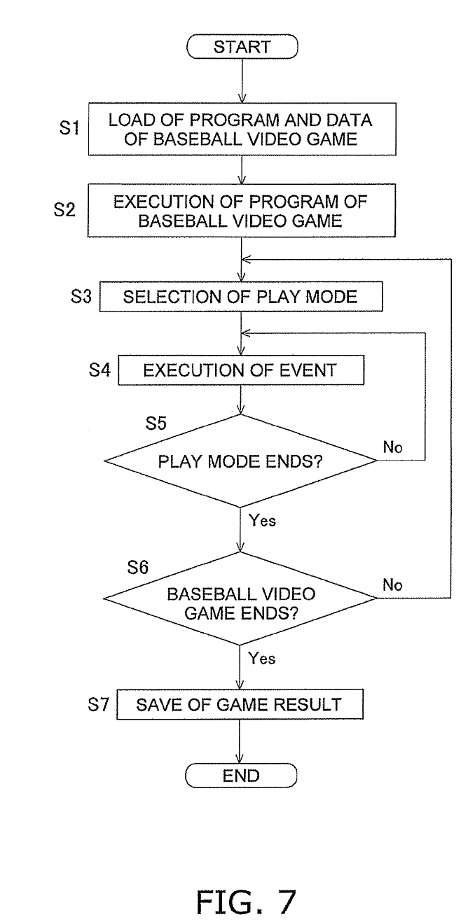

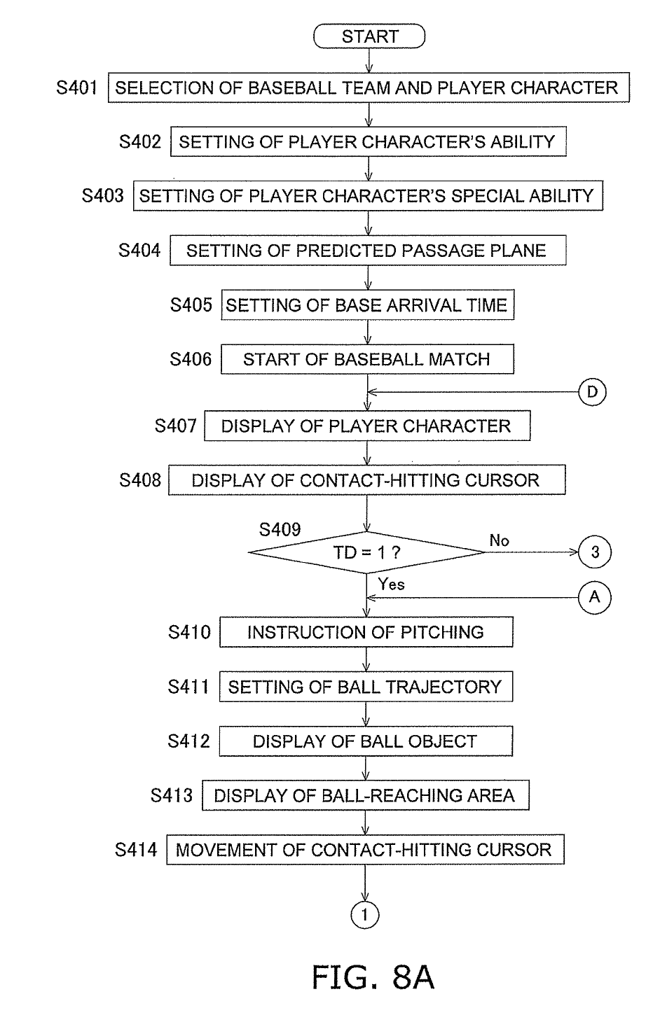

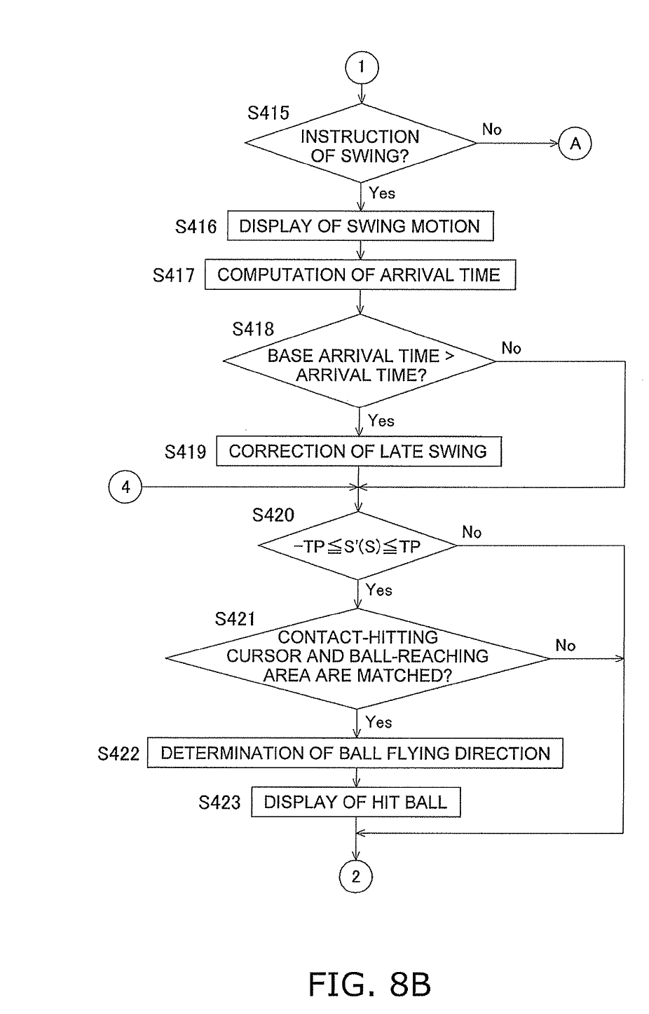

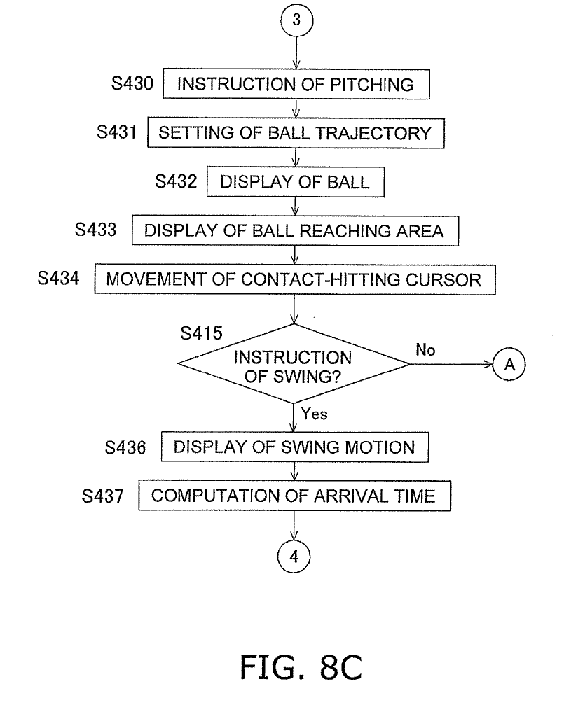

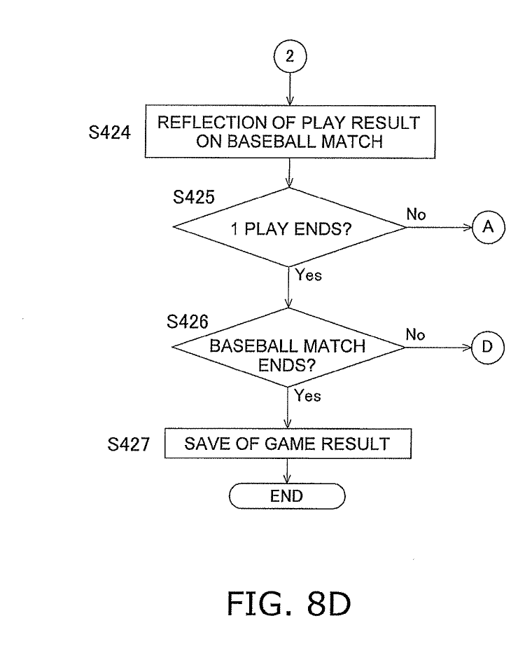

Next, a swing speed correction system in the baseball video game will be hereinafter specifically explained. Simultaneously, processing flows illustrated in FIGS. 7 and 8 will be hereinafter explained. FIG. 7 is a processing flow for explaining the summary of the entire baseball video game while FIG. 8 is a processing flow for explaining the swing speed correction system.

First, when the game console is powered on and is started, a baseball video game program stored in the recording medium 10 is loaded into the RAM 12, and is then stored in the RAM 12. Also, the recording medium 10 stores a variety of basic game data necessary for executing the baseball video game. The variety of basic game data are simultaneously loaded into the RAM 12, and are then stored in the RAM 12 (Step S1).

For example, the basic game data includes a variety of image data for the three-dimensional game space (e.g., image data of baseball stadiums, baseball player characters, and a variety of objects). The variety of image data are recognized by the CPU 7. Also, the basic game data includes position coordinate data for arranging the variety of the above-mentioned image data in the three-dimensional game space. Furthermore, the basic game data includes the data to be used for the swing speed correction system.

Next, the CPU 7 executes the baseball video game program stored in the RAM 12 based on the basic game data (Step S2). Accordingly, the start-up screen of the baseball video game is displayed on the television monitor 20. Also, a variety of setting screens are displayed on the television monitor 20 for executing the baseball video game. For example, a mode selection screen (not illustrated in the figure) is displayed on the television monitor 20 for selecting a playing mode of the baseball video game.

The game player selects the playing mode through the mode selection screen by operating the controller 17 (Step S3). For example, a match-up mode, a pennant-race mode, a developing mode, and a virtual growth mode are prepared as the playing modes. In the match-up mode, the game player selects one of 12 Japanese baseball teams (or one of 30 baseball teams in a major league baseball video game), and enjoys playing single baseball match. In the pennant-race mode, the game player selects one of 12 Japanese baseball teams and enjoys playing baseball matches in the pennant race. In the developing mode, the game player develops baseball player characters as a manager of a baseball team. In the virtual growth mode, the game player virtually experiences the baseball game as the baseball player character.

Next, the CPU 7 executes a variety of events in the playing mode selected through the mode selection screen (Step S4). For example, the events include an event automatically controlled by the CPU 7 based on the AI program, and an event manually controlled by the game player based on an input signal from the controller 17. Also, controls of baseball player characters are classified into the automatic control and the manual control. The automatic control automatically gives a command to a baseball player character based on the AI program. On the other hand, the manual control directly gives a command to the baseball player character based on an input signal from the controller 17. Thus, according to the present baseball video game, an event is controlled and a command is given to the baseball player character in accordance with commands from the controller 17 and the AI program.

Here, the AI program is a program for controlling the command of the event and the command to be given to the baseball player character on behalf of the game player. The AI program is preliminarily prepared in the game program.

Next, the CPU 7 determines whether or not the selected playing mode was terminated (Step S5). Specifically, the CPU 7 determines whether or not a command for indicating termination of the playing mode was issued. When the CPU 7 determined that the command for indicating termination of the playing mode was issued (Yes in Step S5), the CPU 7 executes processing of storing data for continuing the game in the RAM 12. After the game continuation data is stored in the RAM 12, a selection screen is displayed on the television monitor 20 for allowing the game player to select if he/she stops playing the baseball video game (Step S6). Then, when the game player selected an item for terminating the baseball video game through the selection screen by operating the controller 17 (Yes in Step S6), the CPU 7 executes processing of terminating the baseball video game (Step S7). On the other hand, when the game player selected an item for continuing the baseball video game through the selection screen by operating the controller 17 (No in Step S6), the mode selection screen in Step S3 is redisplayed on the television monitor 20.

Unless the CPU 7 determined that the command for terminating the playing mode was issued (No in Step S5), the CPU 7 executes a variety of events in the playing mode selected through the mode selection screen (Step S4).

Next, the swing speed correction system for setting an ability of the baseball player character will be hereinafter explained in detail.

The following is an example of the swing speed correction system functioning in the match-up mode. For example, when the match-up mode is selected through the mode selection screen, the swing speed correction system functions.

In Step S401, when the game player selects the match-up mode through the mode selection screen, teams (i.e., teams A and B) are selected through a team selection screen (not illustrated in the figure). Additionally, baseball player characters of the both teams (i.e., the teams A and B) are selected through the player selection screen (not illustrated in the figure).

In the present example, the team A is set to bat first while the team B is set to take the field first. Also, the game player controls the team A while the AI program controls the team B. Especially, the following example describes the swing speed correction system functions when the game player gives a command to the batter character 80 of the team A.

When the teams A and B are selected through the team selection screen and a starting lineup of each team is selected through the player selection screen, the CPU 7 recognizes identification number ID for identifying the starting lineup of each team. For example, a unique number is prepared for each baseball player character as the identification number ID for identifying the starting lineup of each team. Then, the CPU 7 allocates the unique identification number ID to each baseball player character of each team selected through the player selection screen. Additionally, the CPU 7 recognizes the identification number ID allocated to each baseball player character.

The relation between each baseball player character and the identification number ID is described in a correspondence table. The correspondence table is preliminarily determined in the game program. When the game program is loaded, the correspondence table is provided from the recording medium 10 to the RAM 12, and is stored in the RAM 12.

Then, the CPU 7 executes basic settings with respect to each baseball player character. For example, a setting of an ability of each baseball player is herein executed as one of the basic settings (Step S402). In this case, the baseball player character has a single or plurality of abilities “n”, and the single or plurality of abilities n are evaluated with ability data NT (ID, n) of the baseball player character. The single or a plurality of abilities of the baseball player character are set by causing the CPU 7 to recognize the ability data NT (ID, n) of the baseball player character (Step S404).

For example, the single or plurality of abilities n include “ball-trajectory” (n=1), “power” (n=2), “base-running skill” (n=3), “throwing ability” (n=4), “fielding ability” (n=5), “ball-velocity” (n=6), “ball-control” (n=7), and “toughness” (n=8). The ability data NT (ID, n) corresponding to each of the single or plurality of abilities n is stored in the RAM 12. Thus, the single or plurality of abilities of each baseball player characters are set by causing the CPU 7 to recognize the ability data NT (ID, n) stored in the RAM 12. In the initial state, the CPU 7 recognizes each of the predetermined ability property data stored in the RAM 12 (i.e., initial data).

Specifically, the ability data corresponding to the power ability (n=2) of the baseball player character with a player character ID “1” is expressed with “NT (1, 2)=X”. The symbol “X” is the number for indicating magnitude of the power ability. The greater the ability data NT (1, 2), the greater the power ability of the baseball player character. The other abilities are evaluated in the same way. Each ability of the baseball player character is used when the baseball player performs batting, base-running, fielding, pitching, and the like.

Also, the basic settings include a setting of the special ability of each baseball player character (Step S403). Whether or not the baseball player character includes a single or a plurality of special abilities “tn” is evaluated based on special ability data TD (ID, tn) of the baseball player character. The single or plurality of special abilities of each baseball player character are set by causing the CPU 7 to execute processing of allocating a predetermined value to the special ability data TD (ID, tn) of the baseball player character.

For example, “speeding-up of swing” (tn=1) and “slugger in base-loaded situations” (tn=2) are prepared as the special abilities tn. The CPU 7 determines whether or not the batter character 80 includes the single or plurality of special abilities tn based on value of the special ability data TD (ID, tn).

Specifically, when the batter character 80 (ID=1) includes a special ability “speeding-up of swing” (tn=1), the special ability data is expressed with “TD (1, 1)=1”. When the batter character 80 (ID=1) does not include the special ability “speeding-up of swing” (tn=1), the special ability data is expressed with “TD (1, 1)=0”. The other abilities are evaluated in the same way. As described below, it is determined whether or not the batter character 80 includes a special ability based on whether value of the special ability data TD (ID, tn) is equals to “1” or “0”.

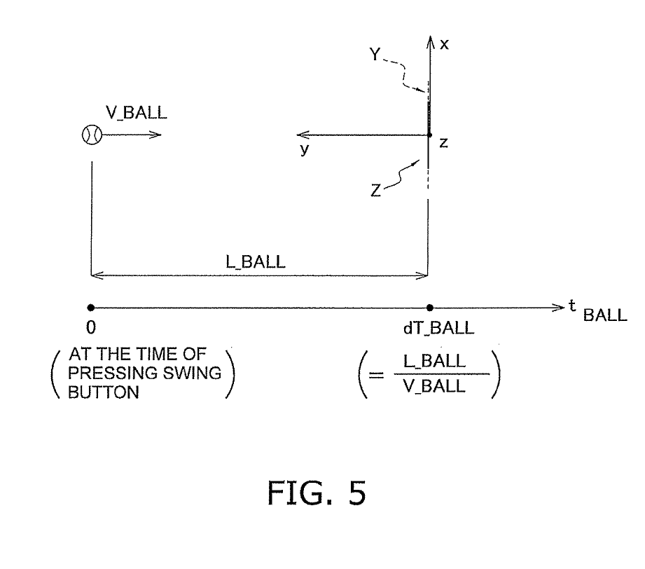

Next, a predicted passage plane Y is set by causing the CPU 7 to recognize a coordinate for determining the predicted passage plane Y through which the ball released by the pitcher character 70 passes (Step S404). As illustrated in FIG. 5, x, y, and z directions are set as follows. The y-direction is defined as a direction from the center of mass of the home plate to the center of mass of the pitcher's plate while the center of mass of the home plate is set to the origin. The z-direction is defined as the direction from the center of mass of the home plate to the upper perpendicular direction. The x-direction is defined as a direction extending from the center of mass of the home plate to be perpendicular to the y and z directions. Also, the x-z plane is defined above the center of mass of the home plate, and corresponds to the predicted passage plane Y. In other words, the predicted passage plane Y is set by causing the CPU 7 to recognize the coordinate of the center of mass of the home plate.

Next, base arrival time KT is set (Step S405). The base arrival time KT is the period of time elapsing since the batter character 80 starts the swing motion until the bat moving in conjunction with the swing motion of the batter character 80 arrives at the predicted passage plane Y. Here, the base arrival time KT has a predetermined range of time. Minimum value KT1 of the predetermined range of time is computed by subtracting predetermined adjustment time CT from predetermined base time HT (=KT). Thus, the minimum value KT1 is expressed with “HT-CT”. On the other hand, maximum value KT2 of the predetermined range of time is computed by adding the predetermined adjustment time CT to the predetermined base time HT (=KT). Thus, the maximum value KT2 is expressed with “HT+CT”. The adjustment time CT is set for adjusting subtle variation in time when the batter character 80 starts the swing motion. The base arrival time KT is set by causing the CPU 7 to recognize the predetermined range of time (KT1≦KT≦KT2).

In the preset example, the base arrival time KT is adjusted. However, the base arrival time KT may not be adjusted. For example, the base arrival time KT is allowed not to be adjusted by replacing hereinafter-used “KT1” and “KT2” with the symbol “KT” of the base arrival time.

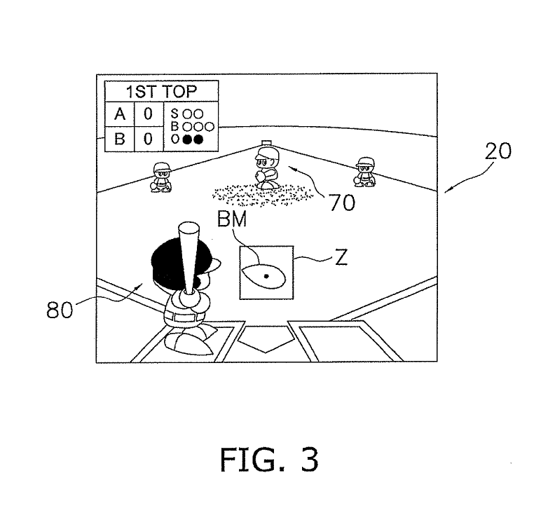

Next, when the CPU 7 issues a baseball match start command for starting the baseball match (Step S406), an image for executing the match-up between the team A and the team B (i.e., baseball match event) is displayed on the television monitor 20. For example, as illustrated in FIG. 3, a variety of images (e.g., images of a stadium, a fielder, and a batter) are displayed on the television monitor 20 with corresponding image data (Step S407). Additionally, a strike zone Z is displayed on the television monitor 20. The strike zone Z is formed in a rectangular shape, and is set on the predicted passage plane Y. Also, the strike zone Z is set by determining coordinates of four corners of the rectangular shape on the predicted passage plane Y. The coordinates of the four corners are preliminarily determined in the game program for determining a range of the strike zone Z. The coordinates of the four corners are stored in the RAM 12.

Furthermore, when the batter character 80 performs the swing motion, an area BM (contact-hitting cursor) is displayed on the television monitor 20 (Step S408). The contact-hitting cursor BM corresponds to an area on the predicted passage plane Y through which the bat passes. Also, the contact-hitting cursor BM is a target of the swing motion of the batter character 80 (i.e., hitting point). The contact-hitting cursor BM is formed in an approximately elliptical shape. Coordinates of the boundary of the contact-hitting cursor BM determines the size thereof. The coordinates are preliminarily determined in the game program, and are stored in the RAM 12.

When a batting command and a fielding command including pitching are given to each baseball player character of the teams A and B in this condition, the baseball player characters perform a variety of motions corresponding to the commands.

For example, the CPU 7 determines whether or not the special ability data corresponding to a single or a plurality of special abilities are set for the batter character 80 of the team A in the top of each inning (Step S409). Specifically, the CPU 7 determines whether or not value of the special ability data TD (ID, tn) of the batter character 80 is equal to “1”. Based on the determination, it is determined whether or not the batter character 80 has the special ability. In short, existence of the special ability of the batter character 80 is determined.

When value of the special ability data (ID, tn) of the batter character 80 is equal to “1”, the batter character 80 is determined to have the special ability tn. On the other hand, when value of the special ability data (ID, tn) of the batter character 80 is not equal to “1”, in other words, when value of the special ability data (ID, tn) of the batter character 80 is equal to “0”, the batter character 80 is determined not to have the special ability tn. Thus, it is possible to control existence of the special ability of the batter character 80 with use of the special ability data TD (ID, tn).

In the following example, only the special ability “speeding-up of swing” is prepared for the batter character 80 for simplifying explanation of the swing speed correction system. In Step S409, the CPU 7 determines whether or not the batter character 80 has the special ability corresponding to “speeding-up of swing”. In other words, the CPU 7 determines whether or not value of the special ability data TD (ID, 1) of the batter character 80 is equal to “1”.

When the CPU 7 determines that value of the special ability data TD (ID, 1) of the batter character 80 is equal to “1” (Yes in Step S409), a pitching command is given to the pitcher character 70 of the team B on the top of each inning based on a command from the AI program (Step S410). For example, the pitching command includes a pitch selection command, a pitching motion start command for the pitcher character 70, and a pitching trajectory determination command.

When the CPU 7 issues the above-mentioned commands, trajectory of the ball released by the pitcher character 70 is set based on a ball-trajectory equation (Step S411). For example, in the ball-trajectory equation, ball-velocity corresponding to a pitch is set to the initial velocity. Additionally, a coordinate of a ball release position is set to a starting point while a coordinate on a pitching trajectory is set to an ending point. Specifically, the CPU 7 computes the ball-trajectory equation while using ball-velocity corresponding to each pitch, the coordinate of the ball release position, the coordinate on the pitching trajectory, and data having an impact on the ball trajectory (e.g., gravity and rotational amount of the ball) as initial conditions.

For example, when a parameter regarding ball-acceleration “a” and ball-velocity “v”, a parameter regarding the ball position, and a parameter regarding data having an impact on the ball trajectory are set to “f(a, v; t)”, “h (xo, yo, zo; t)”, and “g(t)”, respectively, the ball-trajectory equation K is expressed with “K(x, y, z; t)=f(a, v; t)+h(xo, yo, zo; t)+g(t)”. It is possible to compute the ball position (x, y, z; t) at a moment “t” by solving the ball-trajectory equation K. In other words, it is possible to set the ball trajectory to be released by the pitcher character 70.

Detailed description of each parameter in the ball-trajectory equation K is herein omitted, but each parameter is expressed by at least either a linear equation or a polynomial equation. The ball-trajectory equation K is preliminarily determined in the game program, and is stored in the RAM 12.

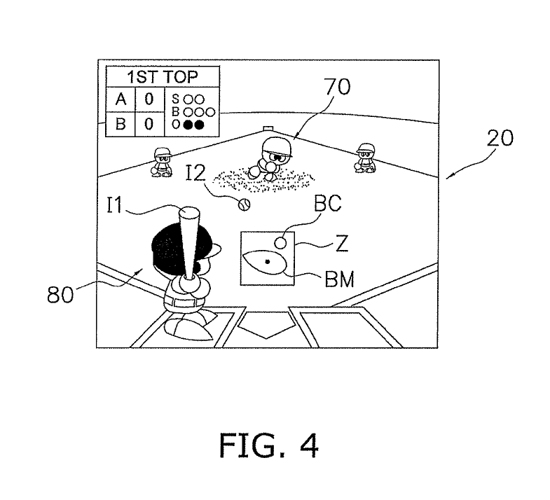

When the ball trajectory is set, a series of pitching motions of the pitcher character 70 are displayed on the television monitor 20. As illustrated in FIG. 4, the ball released by the pitcher character 70 is displayed on the television monitor 20 (Step S412). When the ball released by the pitcher character 70 is seen in the three-dimensional game space, the ball moves on the above-mentioned ball trajectory.

When the ball is released by the pitcher character 70, an area BC (ball-reaching area) is set, and the area BC is circularly displayed on the predicted passage plane Y (Step S413). The area BC is reflection of the ball moving in the three dimensional game space onto the predicted passage plane Y.

Specifically, when the CPU 7 issues a pitching command based on the AI program, the CPU 7 recognizes a position coordinate obtained by reflecting a position coordinate of the ball moving in the three dimensional game space onto the predicted passage plane Y. In other words, the CPU 7 recognizes a coordinate indicating the predicted passage position of the ball on the predicted passage plane Y (i.e., a position of the ball-reaching area BC, a position of the center of mass of the ball-reaching area BC, and a position of the center of the ball-reaching area BC). When the CPU 7 thus recognizes the position of the ball-reaching area BC, a range of the ball-reaching area BC is determined based on the position of the ball-reaching area BC. Accordingly, the CPU 7 recognizes coordinates within the ball-reaching area BC. Thus, the position and the range of the ball-reaching area BC are set.

Next, when the ball is released by the pitcher character 70 and the ball-reaching area BC is displayed on the television monitor 20, the game player operates a predetermined key of the controller 17 (i.e., any one of the up key 17U, the down key 17D, the left key 17L, and the right key 17R) for overlapping the contact-hitting cursor BM with the ball-reaching area BC on the television monitor 20. Accordingly, the CPU 7 executes processing of consecutively moving the coordinate indicating the position (i.e., position of the center of mass) of the contact-hitting cursor BM in accordance with the amount of operation of the predetermined key of the controller 17. Then, area (i.e., boundary) of the contact-hitting cursor BM is set based on the position of the contact-hitting cursor BM. Additionally, a series of motions of the contact-hitting cursor BM moving in the direction instructed through the controller 17 are displayed on the television monitor 20 (Step S414). Here, the CPU 7 recognizes coordinates within the contact-hitting cursor BM moving on the predicted passage plane Y at a predetermined time interval. For example, the CPU 7 recognizes the coordinates within the contact-hitting cursor BM at an interval of 1/60 seconds.

Then, the CPU 7 determines whether or not a predetermined button of the controller 17 is operated for starting the swing motion of the batter character 80 (Step S415). For example, the CPU 7 determines whether or not the input signal is received from the controller 17 for starting the swing motion of the batter character 80. Then, when the CPU 7 determines that the predetermined button of the controller 17 was operated (Yes in Step S415), the CPU 7 issues a command for causing the batter character 80 to start the swing motion (i.e., swing motion start command). Then, the batter character 80 and the bat moving in conjunction with the swing motion of the batter character 80 are displayed on the television monitor 20 with the image data corresponding to the batter character 80 and the bat (Step S416).

On the other hand, when the CPU 7 determines that the predetermined button of the controller 17 was not operated (No in Step S415), that is, when the ball arrived at the predicted passage plane Y, the CPU 7 re-executes processing in Step S410.

Next, when the CPU 7 issues the swing motion start command (Yes in Step S415) and a series of the swing motion of the batter character 80 is displayed on the television monitor 20 (Step S416), arrival time dT_BALL is computed based on distance L_BALL (i.e., arrival distance) and velocity V_BALL. Here, the arrival time dT_BALL is the period of time elapsing since the ball is released by the pitcher character 70 until the ball arrives at the predicted passage plane Y. The distance L_BALL is distance from the position of the ball when the CPU 7 issues the swing motion start command to the predicted passage plane Y. The velocity V_BALL is velocity of the ball when the CPU 7 issues the swing motion start command. For example, the CPU 7 executes processing of dividing the distance L_BALL by the moving velocity V_BALL (see FIG. 5). Accordingly, the arrival time dT_BALL is computed with “L_BALL/V_BALL” (Step S417).

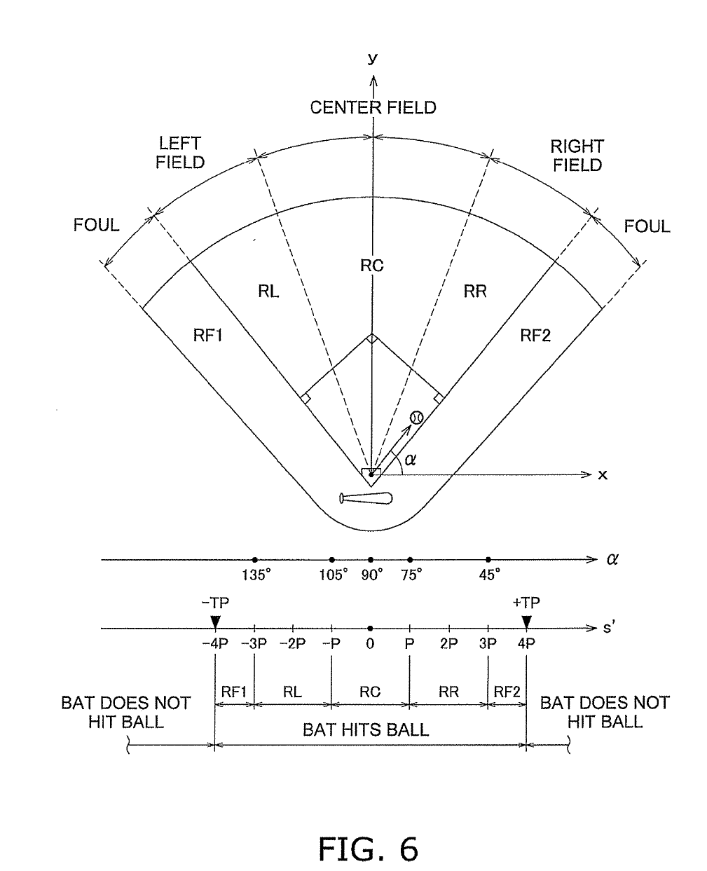

For easy explanation, FIG. 6 illustrates that the ball linearly moves in a direction perpendicular to the predicted passage plane Y at the constant velocity when the CPU 7 issues the swing motion start command.

As described below, however, it is possible to compute the arrival time dT_BALL based on the arrival distance L_BALL when the CPU 7 issues the swing motion start command and the velocity V_BALL even when the ball does not linearly move in a direction perpendicular to the predicted passage plane at the constant velocity.

For example, it is possible to compute velocity of the ball at a moment by causing the CPU 7 to execute processing of differentiating the ball-trajectory equation while the velocity V_BALL of the ball when the CPU 7 issues the swing motion start command is set as an initial condition. Furthermore, it is possible to compute a moment by causing the CPU 7 to execute processing of dividing distance between the position of the ball at a moment and the position of the ball at the next moment by velocity of the ball at a moment, while the position of the ball when the CPU 7 issues the swing motion start command is set as a reference point. The processing is executed in a positional range from the position of the ball when the CPU 7 issues the swing motion start command to a position of the intersection between the ball-trajectory equation and the predicted passage plane Y. Accordingly, it is possible to compute the arrival time dT_BALL elapsing since the ball is released by the pitcher character 70 until the ball arrives at the predicted passage plane Y.

Then, the CPU 7 determines whether or not the base arrival time KT with the predetermined range of time is greater than the arrival time dT_BALL (Step S418). Specifically, the CPU 7 determines whether or not the maximum value KT2 of the base arrival time KT is greater than the arrival time dT_BALL. Thus, it is possible to adjust variation in input timings, for instance, arising from a jiggle of a game player's hand operating the controller 17, by comparing the base arrival time KT and the arrival time dt_BALL with use of the maximum value KT2 of the base arrival time KT.

In the following example, the CPU 7 executes processing of correcting a late swing of the batter character 80 when the batter character 80 swings late. However, the CPU 7 may execute processing of correcting a swing timing of the batter character 80 when the batter character 80 swings the bat at early timing. In this case, the CPU 7 determines whether or not the minimum value KT1 of the base arrival time KT is less than the arrival time dT_BALL. When the minimum value KT1 of the base arrival time KT is less than the arrival time dT_BALL, the CPU 7 corrects the swing timing of the batter character 80.

In this case, the CPU 7 executes processing of adding correction time MT for correcting the base arrival time KT to the minimum value KTI of the base arrival time KT (KT′=KT1+MT). With the processing, difference “S” is reduced between the base arrival time KT required for the arrival of the bat at the predicted passage plane Y and the arrival time dT_BALL required for the arrival of the ball at the predicted passage plane Y. In other words, when the batter character 80 swings the bat at early timing, the CPY 7 executes processing of correcting the swing timing of the batter character 80. Thus, it is possible to adjust variation in input timings, for instance, arising from a juggle of a game player's hand operating the controller 17 by comparing the base arrival time KT and the arrival time dT_BALL with the minimum value KT1 of the base arrival time KT.

Next, when the CPU 7 determines that the maximum value KT2 of the base arrival time KT is greater than the arrival time dT_BALL (Yes in Step S418, KT2>dT_BALL), the CPU 7 executes processing of subtracting the correction time MT for correcting the base arrival time KT from the maximum value KT2 of the base arrival time KT (KT′=KT2−MT). With the processing, the difference S is reduced between the base arrival time KT required for the arrival of the bat at the predicted passage plane Y and the arrival time dT_BALL required for the arrival of the ball at the predicted passage plane Y. In other words, when the batter character 80 performs a late swing, the CPU 7 executes processing of correcting the late swing of the batter character 80 (Step S419).

In this case, the correction time MT is set to a period of time greater than “0 (zero)” and less than the maximum value KT2 of the base arrival time KT. The correction time MT is constant, and is set to 0.1 seconds. The correction time MT is preliminarily determined in the game program, and is stored in the RAM 12.

When the CPU 7 determines that the maximum value KT2 of the base arrival time KT is equal to or less than the arrival time dT_BALL (No in Step S418, KT2≦dT_BALL), the CPU 7 executes processing in after-mentioned Step S420. In this case, the difference used in Step S420 is not the difference S′ between the corrected base arrival time KT′ and the arrival time dT_BALL, but the difference S between the base arrival time KT (KT2) and the arrival time dT_BALL.

When processing of correcting the late swing of the batter character 80 is executed, the CPU 7 determines whether or not the difference S′ between the corrected base arrival time KT′ and the arrival time dT_BALL (=KT′−dT_BALL) falls in the predetermined range of time (Step S420). For example, the CPU 7 determines whether or not the difference S′ between the corrected base arrival time KT′ and the arrival time dT_BALL is equal to or greater than “−TP(=−4p/60)” and simultaneously equal to or less than “TP(=4p/60)” (see FIG. 6). In this case, “p” is a positive integer. When the difference S′ (i.e., KT′−dT_BALL) is equal to or greater than “−TP(seconds)” and simultaneously equal to or less than “TP(seconds)”, it is determined that the bat and the ball temporally collide.

When it is determined that the bat and the ball temporally collide (Yes in Step S420), the CPU 7 determines whether or not the bat hits the bal (Step S421). For example, the CPU 7 determines whether or not a coordinate within the contact-hitting cursor BM is matched with a coordinate within the ball-reaching area BC. Thus, it is determined whether or not the bat and the ball spatially collide. In other words, it is determined whether or not the ball is hit back by the bat. When the coordinate within the contact-hitting cursor BM is matched with the coordinate within the ball-reaching area BC (Yes in Step S421), that is, when the bat and the ball spatially collide, the bat and the ball are determined to temporally and spatially collide. In short, the ball is hit back by the bat.

When a condition in Step S420 or Step S421 is determined to be “No”, the bat and the ball do not temporally and/or spatially collide. For example, when a condition in Step S420 is determined to be “No”, the batter character 80 swings the bat at an erroneous timing and misses the ball. On the other hand, when a condition in Step S421 is determined to be “No”, the batter character 80 swings the bat at an appropriate timing for hitting the ball but misses the ball because the batter character 80 does not spatially-appropriately swing the bat for hitting the ball.

Then, the CPU 7 executes processing of comparing the corrected base arrival time and the arrival time, and a moving direction of the ball is determined in accordance with a result of the comparison (Step S422). For example, when the difference S′ between the corrected base arrival time KT′ and the arrival time dT_BALL is equal to or greater than “−3p/60 (seconds)” and less than “−p/60 (seconds)”, the batter character 80 swings the bat at early timing. In this case, when the bat hits the ball, the hit ball flies in the direction of the left field. Additionally, when the difference S′ between the corrected base arrival time KT′ and the arrival time dT_BALL is greater than “p/60 (seconds)” and equal to or less than “3p/60 (seconds)”, the batter character 80 swings late. In this case, when the bat hits the ball, the hit ball fies in the direction of the right field. Furthermore, when the difference S′ between the corrected base arrival time KT′ and the arrival time dT_BALL is equal to or greater than “−p/60 (seconds)” and equal to or less than “p/60 (seconds)”, this corresponds to a case other than the above-mentioned two cases. In this case, when the bat hits the ball, the hit ball flies in the direction of the center field.

Also, in addition to the above-mentioned comparison, when the difference S′ between the corrected base arrival time KT′ and the arrival time dT_BALL is a negative number and gets smaller, the moving direction of the ball is accordingly set to be close to the direction of the left field or the direction of the foul zone on the third base. In other words, when the difference S′ between the corrected base arrival time KT′ and the arrival time dT_BALL is less than “−1p/60” and simultaneously closer to “−3p/60”, the moving direction of the ball is accordingly set to be close to the direction of the left field close to the third base line. Additionally, when the difference S′ between the corrected base arrival time KT′ and the arrival time dT_BALL is less than “−3p/60” and simultaneously closer to “−4p/60”, the moving direction of the ball is accordingly set to be close to the direction of the foul zone away from the third base line.

Similarly, when the difference S′ between the corrected base arrival time KT′ and the arrival time dT_BALL is a positive number and simultaneously gets larger, the moving direction of the ball is accordingly set to the direction of the right field or the direction of foul zone on the first base. In other words, when the difference S′ between the corrected base arrival time KT′ and the arrival time dT_BALL is greater than “1p/60” and simultaneously closer to “3p/60”, the moving direction of the ball is accordingly set to the direction of the right field closer to the first base line. Furthermore, when the difference S′ between the corrected base arrival time KT′ and the arrival time dT_BALL is greater than “3p/60” and simultaneously closer to “4p/60”, the moving direction of the ball is accordingly set to the direction of the foul zone away from the first base line.

In the present example, when the difference S′ between the corrected base arrival time KT′ and the arrival time dT_BALL gets closer to “0 (zero)”, the moving direction of the ball is accordingly set to be closer to the direction of the center field. Additionally, when the difference S′ between the corrected base arrival time KT′ and the arrival time dT_BALL is less than “0 (zero)” and simultaneously closer to “−1p/60”, the moving direction of the ball is accordingly set to be closer to the direction of the center field close to the left field. Furthermore, when the difference S′ between the corrected base arrival time KT′ and the arrival time dT_BALL is greater than “0 (zero)” and simultaneously closer to “1p/60”, the moving direction of the ball is accordingly set to be closer to the direction of the center field close to the right field.

As described above, the moving direction of the ball is set in accordance with the difference S′ between the corrected base arrival time KT′ and the arrival time dT_BALL. For example, as illustrated in FIG. 6, flying-ball angle “α” is set around the origin in the three dimensional game space (i.e., the center of mass of the home plate). In this case, the flying-ball angle α is set in accordance with the difference S′ between the corrected base arrival time KT′ and the arrival time dT_BALL.

For easy explanation, the flying-ball angle in the height direction is not illustrated in the figure. Therefore, the flying ball angle in the height direction will be hereinafter briefly explained. When the center of mass of the ball-reaching area BC is overlapped with or positioned above the center of mass of the contact-hitting cursor BM while the center of mass of the contact-hitting cursor BM is set as a reference point, the flying-ball angle in the height direction is set to correspond to a liner or a fly ball. On the other hand, when the center of mass of the ball-reaching area BC is positioned below the center of mass of the contact-hitting cursor BM while the center of mass of the contact-hitting cursor BM, the flying-ball angle in the height direction is set to correspond to a ground ball. In this case, relation among the herein set flying-ball angle, the contact-hitting cursor BM, and the ball-reaching area BC is preliminarily determined in the game program. For example, a table for indicating correspondence among the flying-ball angle, the contact-hitting cursor BM, and the ball-reaching area BC is stored in the RAM 12.

When the moving direction of the ball is thus set based on the flying-ball angle. The ball hit back by the batter character 80 is displayed on the television monitor 20 with the ball's image data (Step S423). In other words, a series of motions that the ball hit back by the batter character 80 moves in the above-mentioned moving direction are displayed on the television monitor 20 with the ball's image data.

Then, the CPU 7 determines a play result that the batter character 80 hit the ball, and executes processing of reflecting the play result in the baseball match event (Step S424). For example, when the batter character 80 is forced “out” as a result, the CPU 7 executes processing of incrementing out count by one. On the other hand, when the batter character 80 hits any of “single (hit)”, “double (2-base hit)”, “triple (3-base hit)”, and “home run” as a result, the CPU 7 executes processing of causing a runner to go to the next base. Furthermore, when the offensive team herein gets a score, the CPU 7 executes processing of adding a score. Also, when the batter character 80 hits a “foul ball”, the CPU 7 executes processing of incrementing strike count by one. Furthermore, when the strike count is “two strikes”, the CPU 7 does not execute processing of incrementing the strike count by one. However, this is also treated as one of processing of reflecting the play result in the baseball match event.

Then, the CPU 7 determines whether or not the match-up between the batter character 80 and the pitcher character 70 is completed, that is, if a play is completed (Step S425). When the CPU 7 determines that the play has not been completed yet (No in Step S425), the CPU 7 re-executes processing in Step S410. On the other hand, when the CPU 7 determines that the play was completed (Yes in Step S425), the CPU 7 determines whether or not the baseball match event is completed (Step S426). Then, when the CPU 7 determines that baseball match event was completed (Yes in Step S426), the CPU 7 executes processing of terminating the baseball video game (Step S427). On the other hand, when the CPU 7 determines that the baseball match event has not been completed yet (No in Step S426), the CPU 7 re-executes processing in Step S407.

When the CPU 7 determines that value of the special ability data TD (ID, 1) of the batter character 80 is not equal to “1” (No in Step S409), that is, when the CPU 7 determines that value of the special ability data TD (ID, 1) of the batter character 80 is equal to number “0”, processing of correcting the late swing of the batter character 80 is not executed. In other words, in the present embodiment, processing of correcting the late swing of the batter character 80 is executed only when the batter character 80 has the special ability. Therefore, when a condition in Step S409 is determined to be “No”, the CPU 7 executes processing in Steps S430 to S437. The processing in Steps S430 to S437 are the same as the above-mentioned Steps S410 to S417. Then, when the CPU 7 executes processing in Steps S430 to S437, the CPU 7 executes processing in Step 420 and subsequent Steps. In this case, the difference to be used in Step S420 is not the difference S′ between the corrected base arrival time KT′ and the arrival time dT_BALL, but the difference S between the base arrival time KT (KT2) and the arrival time dT_BALL.

### OTHER EXAMPLE EMBODIMENT

(a) In the above-mentioned embodiment, the home video game device is used as an example of a computer that the game program is allowed to be applied. However, the game device is not limited to the above-mentioned embodiment. The game device may be applied to a game device that a monitor is separately provided, a monitor-integrated game device, a personal computer or a workstation functioning as a game device when a game program is executed therein, and the like, as well.

(b) In the example of the above-mentioned embodiment, the present invention is applied to the baseball video game. However, the present invention is not limited to the above-mentioned embodiment. The present invention may be applied to other video games. For example, the present invention may be applied to a tennis video game while a tennis racket is used as a predicted passage plane.

(c) The present invention includes a program for executing the above-mentioned game and a computer-readable recording medium storing the program. For example, a computer-readable flexible disk, a semiconductor memory, a CD-ROM, a DVD, a MO, a ROM cassette, and the like may be suggested as the recording medium other than the cartridge.

### GENERAL INTERPRETATION

A used herein, the following directional terms “forward, rearward, above, downward, vertical, horizontal, below and transverse” as well as any other similar directional terms refer to those directions of a device equipped with the present invention. Accordingly, these terms, as utilized to describe aspects of the present invention, should be interpreted relative to a device equipped with the present invention.

The term “configured” as used herein to describe a component, section or part of a device includes hardware and/or software that is constructed and/or programmed to carry out the desired function.

Terms that are expressed as “means-plus function” in the claims should include any structure that can be utilized to carry out the function of that part of the present invention.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A computer readable medium storing a computer program for a video game in which a first character moves a first moving object and a second character moves a second moving object, the computer program comprising:
code for setting a predicted passage plane through which the second moving object moves;
code for recognizing base arrival time which is a period of time between when the first character starts moving the first moving object and when the first moving object arrives at the predicted passage plane;
code for displaying the second moving object on the image display unit;
code for displaying the first moving object on the image display unit;
code for computing arrival time which is a period of time between when the first character starts moving the first moving object and when the second moving object arrives at the predicted passage plane, in the basis of velocity of the second moving object and distance from a position of the second moving object to the predicted passage plane; and
code for reducing difference between the base arrival time and the arrival time, by adjusting the base arrival time.

2. The computer readable medium according to claim 1, wherein if the base arrival time is larger than the arrival time, the adjusting is reducing the base arrival time.

3. The computer readable medium according to claim 1, wherein
the adjusting is reducing the difference in accordance with velocity of the second moving object.

4. The computer readable medium according to claim 1, the computer program further comprising
code for recognizing a first coordinate of a first passage area on the predicted passage plane, the first passage area through which the first moving object moves,
code for recognizing a second coordinate of a second passage area on the predicted passage plane, the second passage area through which the second moving object moves;
code for comparing the base arrival time adjusted and the arrival time;
code for determining whether or not the first coordinate matches the second coordinate, and
code for determining a moving direction of the second moving object in the basis of result of the comparison and result of the determination.

5. The computer readable medium according to claim 1, wherein
the base arrival time is set to be within a range between the minimum value and the maximum value,
the minimum value is set by subtracting predetermined adjustment time from predetermined base time, and
the maximum value is set by adding the predetermined adjustment time to the predetermined base time.

6. The computer readable medium according to claim 1, the computer program further comprising
code for determining whether the first character has a special ability, wherein
if the first character has the special ability, the adjusting is reducing the difference.

7. A game device for a video game in which a first character moves a first moving object and a second character moves a second moving object, the game device comprising:
predicted passage position recognition means for setting a predicted passage plane through which the second moving object moves;
base arrival time setting means for recognizing base arrival time which is a period of time between when the first character starts moving the first moving object and when the first moving object arrives at the predicted passage plane;
second moving object display means for displaying the second moving object on the image display unit;
first moving object display means for displaying the first moving object on the image display unit;
arrival time computation means for computing arrival time which is a period of time between when the first character starts moving the first moving object and when the second moving object arrives at the predicted passage plane, in the basis of velocity of the second moving object and distance from a position of the second moving object to the predicted passage plane; and
time difference reduction means for reducing difference between the base arrival time and the arrival time, by adjusting the base arrival time.

8. A game control method for controlling a video game in which a first character moves a first moving object and a second character moves a second moving object, the game control method comprising:
setting a predicted passage plane through which the second moving object moves;
recognizing base arrival time which is a period of time between when the first character starts moving the first moving object and when the first moving object arrives at the predicted passage plane;
displaying the second moving object on the image display unit;
displaying the first moving object on the image display unit;
computing arrival time which is a period of time between when the first character starts moving the first moving object and when the second moving object arrives at the predicted passage plane, in the basis of velocity of the second moving object and distance from a position of the second moving object to the predicted passage plane; and
reducing difference between the base arrival time and the arrival time, by adjusting the base arrival time.
